(19) United States
(12) Patent Application Publication
(10) Pub. No.: US 2024/0353168 A1
(43) Pub. Date: Oct. 24, 2024

(54) REFRIGERATOR

(71) Applicant: LG ELECTRONICS INC., Seoul (KR)

(72) Inventors: Jaewon Jung, Seoul (KR); Daekil KANG, Seoul (KR); Jaebok SONG, Seoul (KR)

(73) Assignee: LG ELECTRONICS INC., Seoul (KR)

(21) Appl. No.: 18/591,390

(22) Filed: Feb. 29, 2024

(30) Foreign Application Priority Data
Apr. 20, 2023 (KR) 10-2023-0052316
Sep. 1, 2023 (KR) 10-2023-0116511

(51) Int. Cl. F25D 23/02; E05F 3/20

(52) U.S. Cl. CPC F25D 23/028; E05F 3/20; E05Y 2900/31

(57) ABSTRACT

A refrigerator includes a cabinet which has a storage space; a door which opens and closes the storage space; a hinge which rotatably connects the cabinet and the door; and a damping device which is provided on the door and provides a damping force through oil resistance, in which the hinge is in contact with the damping device while the door is rotated in the closing direction and causes the stroke of the damping device to increase to slow down the door.

### CROSS-REFERENCE TO RELATED APPLICATIONS

The present application claims priority under 35 U.S.C. 119 to Korean Patent Application No. 10-2023-0052316, filed in the Republic of Korea on Apr. 20, 2023, and Korean Patent Application No. 10-2023-0116511, filed in the Republic of Korea on Sep. 1, 2023, both of which are hereby incorporated by reference in their entirety.

### BACKGROUND

The present disclosure relates to a refrigerator.

In general, a refrigerator is a home appliance that allows food to be stored at low temperatures in an internal storage space shielded by a door. To this end, refrigerators are designed to keep stored food in optimal condition by cooling the inside of the storage space using cold air generated through heat exchange with the refrigerant circulating in the refrigeration cycle.

Recently, refrigerators are gradually becoming larger and more multi-functional in accordance with changes in eating habits and the trend of higher quality products, and refrigerators with various structures that take user convenience into consideration are being released.

When a device is provided to provide space for door storage of the refrigerator or to provide additional functions such as an ice maker, dispenser, or transparent panel, or when heavy materials such as glass and metal are used to enhance the outer appearance, the weight of the door increases. Additionally, even when a large amount of food is stored in the door or heavy food is stored, the weight of the door increases.

When the weight of the refrigerator door increases, there is a problem that it takes a lot of effort to open and close the refrigerator door, and the speed at the moment when the door is closed becomes very fast, and thus problems such as noise or items falling may occur due to impact.

### SUMMARY

An object of an embodiment of the present disclosure is to provide a refrigerator that allows the door to close at a constant speed even with various door weights and closing forces. An object of an embodiment of the present disclosure is to provide a refrigerator that improves the quality of door opening and closing operation by preventing a damping force from being applied when the door is closed and a reaction force from being applied when the door is opening.

An object of an embodiment of the present disclosure is to provide a refrigerator in which the damping force is adjusted according to the closing angle of the door so that the door closes smoothly.

A refrigerator according to an embodiment of the present disclosure includes a cabinet which has a storage space; a door which opens and closes the storage space; a hinge which rotatably connects the cabinet and the door; and a damping device which is provided on the door and provides a damping force through oil resistance, in which the hinge may be in contact with the damping device while the door is rotated in the closing direction and may cause the stroke of the damping device to increase to slow down the door. That is, the damping device may have a first damping state that provides a first damping force to the door and a second damping state that provides a second damping force to the door that is less than the first damping force.

The door may include an auto-closing device that automatically closes the door, and the damping device may be in contact with the hinge after the auto-closing device starts operating.

The auto-closing device may be disposed on the same extended line as the rotation center of the door, the auto-closing device may start operating when the opening angle of the door is a set angle, and the damping device may start contacting the hinge at an angle in which the door is opened at an angle smaller than the set angle.

The door may include a first door and a second door, a pair of which are disposed side by side on both left and right sides to shield one storage space, the first door may be provided with a pillar that rotates when the first door is closed to shield the space between the first door and the second door, and the cabinet may include a pillar guide which guides rotation of the pillar.

A damping force of the damping device may be reduced at the hinge while the pillar is in contact with the pillar guide.

The pillar may be in contact with the pillar guide when the opening angle of the first door is a third set angle or less, and the damping force of the damping device may be reduced when the opening angle of the first door is the third set angle or less.

The damping device may be mounted at a position vertically spaced apart from the rotation shaft of the door by a set distance, and a torque may be generated which rotates the door in a direction opposite to the closing direction when the damping device is in contact with the hinge.

The hinge may include a hinge bracket which is connected to the cabinet; a hinge plate which protrudes forward from the hinge bracket; and a hinge shaft which is provided on the hinge plate and is axially coupled to the door, and a contact part in contact with the damping device may be formed on at least a portion of a circumferential surface of the hinge plate.

The damping device may be disposed on a side of the contact part, and the contact part may become farther away from the hinge shaft as the contact part extends from the front to the rear.

The contact part may include a pressing part which extends to increase the distance from the hinge shaft and is in contact with the damping device to increase stroke; and a restraining part which is formed behind the pressing part and maintains a state of being in contact with the damping device when the door is closed.

The contact part may include a holding part which is formed between the pressing part and the restraining part, is formed at the same distance from the hinge shaft, and maintains the stroke.

The restraining part may be recessed at an end portion of the holding part, and the recession depth of the restraining part may be formed to be lower than the radius of curvature of the end portion of the damping member.

The door may be decelerated while the damping device passes the pressing part, and the door may be accelerated while the damping device passes the holding part.

The contact part may include a starting part which is formed in front of the pressing part to start contact with the damping device and maintains a stroke by forming the distance from the hinge shaft equal.

The door may further includes a stopper configured to restrain the door, one end of the stopper may be fixed to the door and the other end thereof may extend to be in contact with the hinge plate, and the hinge plate may include a locking part which is in contact with the stopper and elastically deforms the stopper when the door rotates; and a locking groove which is recessed in the rear of the locking part and restrains an end portion of the stopper.

The contact part may be formed between the hinge bracket and the locking groove.

The damping device may start contact with the contact part after the stopper is in contact with the locking part.

The damping device may include a cylinder which forms a compressed space in which oil is accommodated and has an open surface; a push member which is provided on the cylinder; a sealing cap which shields the opening of the cylinder; a rod which passes through the sealing cap and extends from the inside of the cylinder; a piston which is coupled to the rod, moves in the compression space, and forms an orifice through which the oil passes; and an elastic member which provides elastic force to the piston, and the push member may be pressed while moving in a state of being in contact with the hinge as the door rotates.

A plurality of damping parts may be formed in the compression space in the direction in which the cylinder extends, and the plurality of damping parts may be formed so that their inner diameters increase as the distance from the opening of the cylinder increases, so that the applied damping force decreases.

The piston may slow down the rotational speed of the door as the piston passes through some sections of the plurality of damping parts, and the rotational speed of the door may be accelerated when the piston passes through the damping part farthest from the opening.

The refrigerator according to an embodiment of the present disclosure has the following effects.

According to the present embodiment, a damping force is provided from the damping device in a set section during the rotation motion in which the door is closed, so that the door can be closed while decelerating. In addition, the damping force can be adjusted according to a shape of a contact part of the hinge with which the damping device is in contact, so there is an advantage in that the closing speed of the door can be adjusted.

In particular, the damping device is composed of an oil damper, and the contact part is formed to increase the stroke between the starting point and the ending point, so that the door can be sufficiently decelerated even if the door is heavy or rotates quickly.

Therefore, even when the weight of the door is heavy or the weight of food stored in the door increases or changes, sufficient deceleration is achieved in a certain section of the closing rotation section of the door by the damping device, and thus there is an advantage of providing a soft closing quality and there is an advantage of being able to alleviate impact and noise when the door is closed.

In addition, the contact part maintains a constant stroke at the portion where contact with the damping device starts, which has the advantage of preventing oil impact that may occur due to the structural characteristics of the oil damper. In addition, there is an advantage in that preparations for oil flow are made before the actual damping force is applied to the damping device, so that the door can be decelerated smoothly and effectively.

Additionally, the contact part may maintain a constant stroke of the damping device at a portion immediately before the door is completely closed, thereby preventing a substantial damping force from being applied from the damping device. Therefore, there is an advantage in that stable closing of the door can be guaranteed by allowing the door to rotate at an appropriate speed without decelerating just before the door is closed.

In particular, in a case of a door equipped with a pillar, immediately before the pillar is operated, it is brought into contact with a section where the stroke of the damping device does not increase, so that the damping force is not provided from the damping device, thereby ensuring smooth operation of the pillar and reliable operation of the door.

In addition, when the door is opened, the damping device does not generate a reaction force from the contact part when separated from the contact part due to the characteristics of an oil damper, and the contact part has a shape that does not increase the stroke in the direction in which the door is opened. Therefore, there is an advantage that the door is easier to open because the reaction force caused by the damping device is not applied when the door is opened.

### BRIEF DESCRIPTION OF THE DRAWINGS

FIG. 1 is a perspective view illustrating a refrigerator according to a first embodiment of the present disclosure.

FIG. 2 is a front view illustrating a state where all the doors of the refrigerator are open.

FIG. 3 is a perspective view illustrating a door provided with a pillar among the doors.

FIG. 4 is a cross-sectional view taken along line 4-4 of FIG. 1.

FIG. 5 is a partial perspective view illustrating a state where the door, hinge device, damping device, and auto-closing device are combined.

FIG. 6 is an exploded perspective view illustrating the combined structure of the door, hinge device, damping device, and auto-closing device.

FIG. 7 is a cut-away perspective view illustrating the operating state of the damping device.

FIG. 8 is a partial perspective view from below illustrating a state where the door is rotated in the closing direction.

FIG. 9 is a view illustrating the contact positions of the hinge and damper according to the rotation angle of the door.

FIGS. 10 to 13 are views illustrating changes in the state of the damping device and the door according to the rotation angle of the door.

FIG. 14 is a graph illustrating the change in closing speed over time of the door according to the first embodiment of the present disclosure and the door according to the comparative example.

FIG. 15 is a graph illustrating changes in damping force and closing force according to the opening angle of the door according to the first embodiment of the present disclosure.

FIG. 16 is a cross-sectional view illustrating the damping device and the operating state thereof according to the second embodiment of the present disclosure.

FIGS. 17 to 20 are views illustrating the position of the damping device, the internal state of the damping device, and changes in the state of the pillar according to the rotation of the door.

FIG. 21 is a graph illustrating the change in closing speed over time of the door equipped with the damping device and the door of a comparative example.

FIG. 22 is a partial perspective view illustrating a door according to a third embodiment of the present disclosure.

FIG. 23 is a bottom view illustrating the hinge of the door.

FIG. 24 is a graph illustrating changes in damping force and closing force according to the rotation angle of the door.

FIG. 25 is a partial perspective view illustrating a door according to a fourth embodiment of the present disclosure.

FIGS. 26 to 28 are views illustrating changes in the state of the damping device and the door according to the rotation angle of the door.

FIG. 29 is a graph illustrating changes in damping force and closing force and changes in closing speed according to the rotation angle of the door.

FIG. 30 is a partial perspective view illustrating the door in an open state according to the fifth embodiment of the present disclosure.

FIG. 31 is a partial perspective view illustrating the door in a closed state.

FIGS. 32 to 35 are views illustrating changes in the state of the damper device and the door according to the rotation angle of the door.

FIG. 36 is a graph illustrating the change in damping force and closing force and the change in closing speed according to the rotation angle of the door.

FIG. 37 is a view illustrating the contact state between the hinge and the damping device according to the sixth embodiment of the present disclosure.

FIG. 38 is a view illustrating the contact state between the hinge and the damping device according to the seventh embodiment of the present disclosure.

FIG. 39 is a view illustrating the contact state between the hinge and the damping device according to the eighth embodiment of the present disclosure.

FIG. 40 is a view illustrating the contact state between the hinge and the damping device according to the ninth embodiment of the present disclosure.

FIG. 41 is a view illustrating the contact state between the hinge and the damping device according to the tenth embodiment of the present disclosure.

FIG. 42 is a partial perspective view illustrating a refrigerator equipped with a damper device according to the eleventh embodiment of the present disclosure.

FIG. 43 is a front view illustrating a state where the door of the refrigerator is open according to the twelfth embodiment of the present disclosure.

FIG. 44 is a bottom view illustrating the contact state between the hinge and the damping device of the door.

FIG. 45 is a partial perspective view illustrating the state of the hinge and damping device in a state where the door of the refrigerator according to the thirteenth embodiment of the present disclosure is open.

FIG. 46 is a partial perspective view illustrating the state of the hinge and damping device in a state where the door is closed.

FIG. 47 is a partial perspective view illustrating a refrigerator equipped with a damper device according to the fourteenth embodiment of the present disclosure.

### DETAILED DESCRIPTION OF THE EMBODIMENTS

Hereinafter, specific embodiments of the present disclosure will be described in detail along with the drawings. However, the present disclosure cannot be said to be limited to the embodiments in which the idea of the present disclosure is presented, and other disclosures that are regressive or other embodiments included within the scope of the present disclosure can be easily suggested by adding, changing, or deleting other components.

In addition, various embodiments of the present disclosure are described below, and in order to prevent duplication of description, identical components between each embodiment are denoted by the same reference numerals and detailed descriptions thereof are omitted.

In addition, all or a portion of the configuration of multiple embodiments described below may be combined with each other.

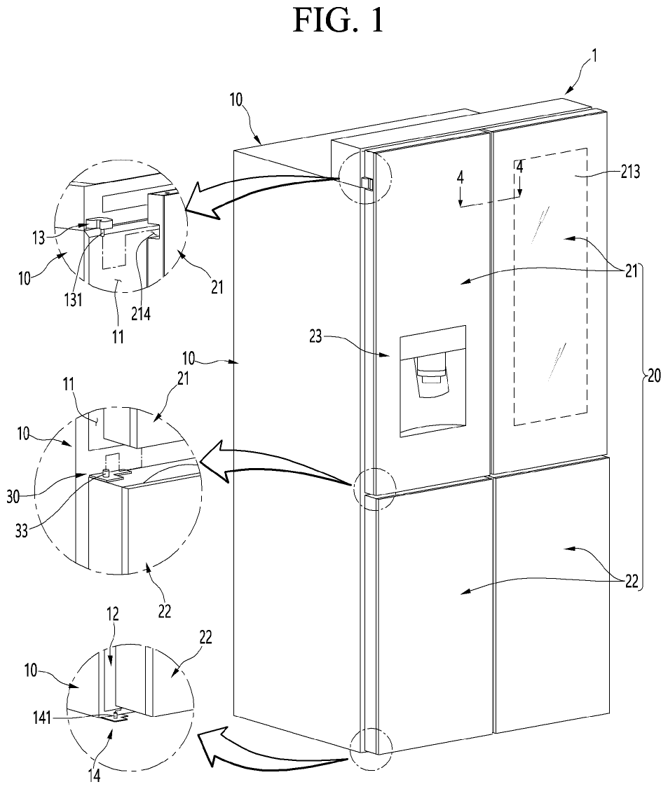

Before explaining the embodiments, various directions are defined. In an embodiment of the present disclosure, the direction in which a front surface of the door illustrated in FIG. 1 faces may be referred to as a front direction, the direction toward the cabinet based on the front surface of the door may be referred to as a rear direction, the direction toward the floor where the refrigerator is installed may be referred to as a lower direction, and the direction away from the floor may be referred to as an upper direction. In addition, when indicating a previously undefined direction, the direction can be defined and explained based on each drawing.

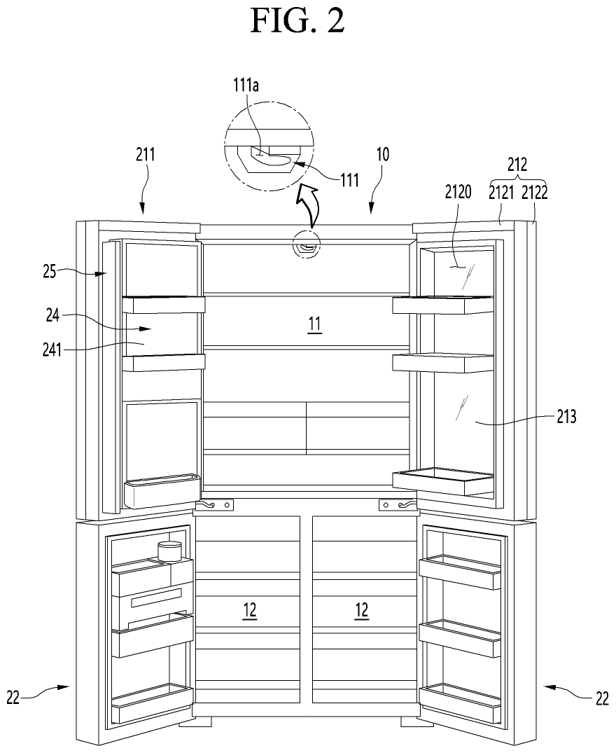

FIG. 1 is a perspective view illustrating a refrigerator according to a first embodiment of the present disclosure, and FIG. 2 is a front view illustrating a state where all the doors of the refrigerator are open.

As illustrated in the drawing, the overall outer appearance of the refrigerator 1 according to an embodiment of the present disclosure may be formed by a cabinet 10 forming a storage space with an open front surface, and a door 20 opening and closing the storage space.

The cabinet 10 may include a storage space with an open front surface. The inside of the cabinet 10 may be composed of an upper storage space 11 and a lower storage space 12 divided up and down. For example, the upper storage space 11 may be a refrigerating chamber and the lower storage space may be a freezing chamber.

A pillar guide 111 may be provided at the center of the upper surface of the upper storage space 11. The pillar guide 111 may be formed with a guide groove 111a to guide the rotational movement of the pillar 25, which will be described below.

A door 20 may be provided in front of the cabinet 10. The door 20 may be provided with a panel on the front that forms an outer appearance. The panel may be made of various materials such as glass, metal, ceramic, and plastic.

There may be a plurality of doors 20, and each door 20 may be configured to independently open and close the storage space by rotating it. As an example, the door 20 may include an upper door 21 that opens and closes the upper storage space 11 and a lower door 22 that opens and closes the lower storage space 12.

The upper end and the lower end of the upper door 21 are supported by hinges 13 and 30, and the upper door rotates about the hinge shafts 131 and 33 of the hinges 13 and 30 to open and close the upper storage space 11. Additionally, a pair of the upper doors 21 may be disposed side by side on both left and right sides. In other words, the upper door 21 may be composed of a left door 211 and a right door 212. The left door 211 may be referred to as a first door, and the right door 212 may be referred to as a second door. In addition, the upper door 21 may be referred to as a refrigerating chamber door. The upper door 21 may have various structures for user convenience.

As an example, a dispenser 23 may be provided on the front of the left door 211. Additionally, an ice maker may be accommodated at the rear surface of the left door 211 and an ice making chamber 24 may be provided that is opened and closed by the ice making chamber door 241. Ice inside the ice-making chamber 24 may be discharged through the dispenser 23.

Additionally, the left door 211 may be provided with a pillar 25, which will be described below.

As another example, the right door 212 may be configured as a double door including a main door 2121 and a sub door 2122. The main door 2121 opens and closes the upper storage space 11 and may include an opening 2120 in communication with the upper storage space 11. The sub door 2122 can open and close the opening 2120 in front of the main door 2121. Additionally, the sub door 2122 may be provided with a transparent panel assembly 213 that can see through the opening 2120.

The upper end and the upper end of the lower door 22 is supported by hinges 30 and 14, and the lower door rotates based on the hinge shafts 35 and 141 of the hinges 30 and 14 to open and close the lower storage space 12. Additionally, a pair of the lower doors 22 may be disposed to be rotatable on both left and right sides. The lower door 22 may be referred to as a freezing chamber door.

In addition, for distinction, the hinge 13 may be referred to as an upper hinge or a first hinge, the hinge 30 may be referred to as a middle hinge or a second hinge, and the hinge 14 may be referred to as a lower hinge.

The door 20 may be configured in various ways according to the disposition of the storage space. In the present embodiment, an example provided with four doors will be described, but it should be noted in advance that the present disclosure is applicable to all refrigerators equipped with at least one rotating door.

Hereinafter, we will look at the mounting structure based on the left door 211 of the upper doors 21. The present disclosure is not limited to the position and shape of the door 20. Additionally, the left door 211 may be called a door 21 for convenience of explanation and understanding.

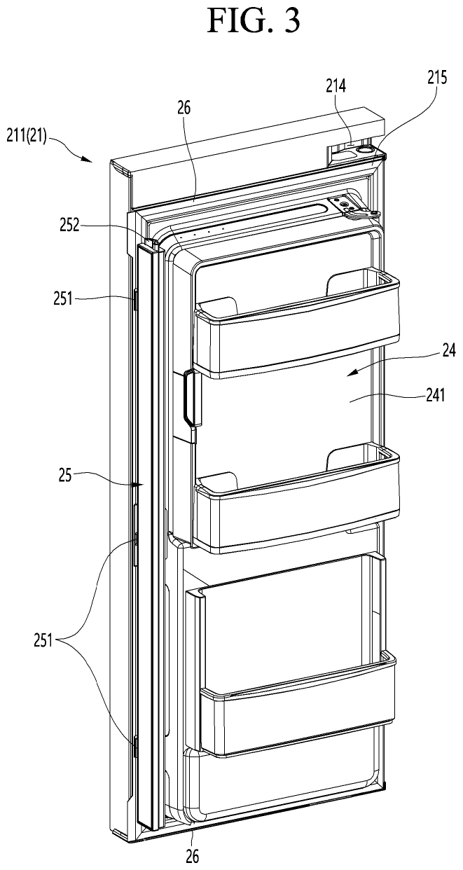

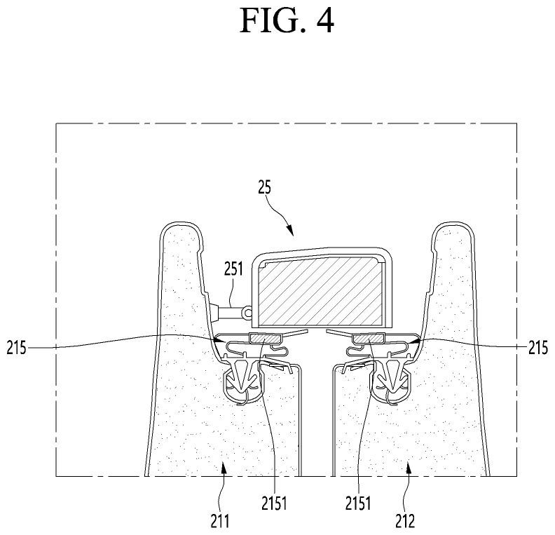

FIG. 3 is a perspective view illustrating a door provided with a pillar among the doors, and FIG. 4 is a cross-sectional view taken along line 4-4 of FIG. 1.

A hinge mounting part 214 on which the hinge 13 is mounted may be formed on the upper portion of the door. The hinge mounting part 214 accommodates the hinge 13, and the hinge shaft 131 of the hinge 13 may be axially coupled. Additionally, a hinge 30 may be mounted on the lower surface of the door 21.

A gasket 215 may be provided around the rear surface of the door 21. The gasket 215 can block cold air leakage by making the space between the door 21 and the cabinet 10 airtight when the door 21 is closed. In addition, a magnet 2151 is built into the gasket 215 so that the magnet can be brought into closer contact with the cabinet 10.

Meanwhile, the door 21 may be provided with the pillar 25. The pillar 25 may be provided on one side of the left and right sides of the door 21 that is farthest from the hinges 13 and 30. The pillar 25 may extend in the vertical direction of the door 21 and may shield the space between the left door 211 and the right door 212 when the upper door 21 is closed.

The pillar 25 may include a connecting part 251 connected to the door 21. The end portion of the connecting part 251 may be rotatably connected to the door 21. Additionally, an elastic member is disposed at the connecting part 251 so that the pillar 25 can be maintained in a folded state as illustrated in FIG. 3 when the door 21 is opened.

A guide protrusion 252 may be provided on the upper portion of the pillar 25. The guide protrusion 252 may be inserted into the guide groove 111a during the process of closing the door 21. Additionally, the pillar guide 111 may rotate the pillar 25 while moving along the guide groove 111a so that the pillar 25 is unfolded. In addition, when the door 21 is completely closed, the pillar 25 is unfolded as illustrated in FIG. 4 to make the space between the left door 211 and the right door 212 airtight.

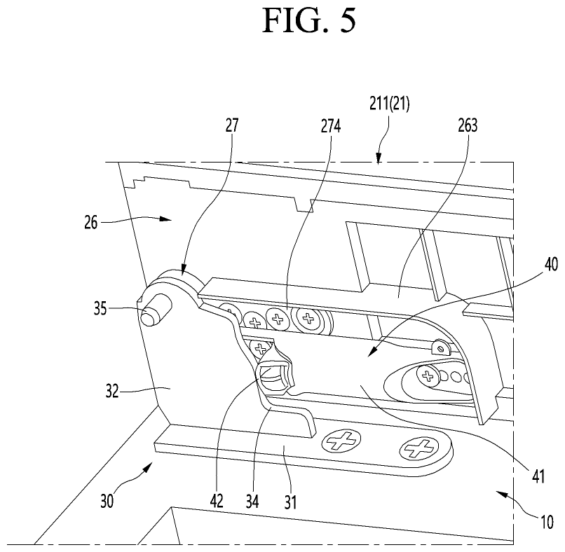

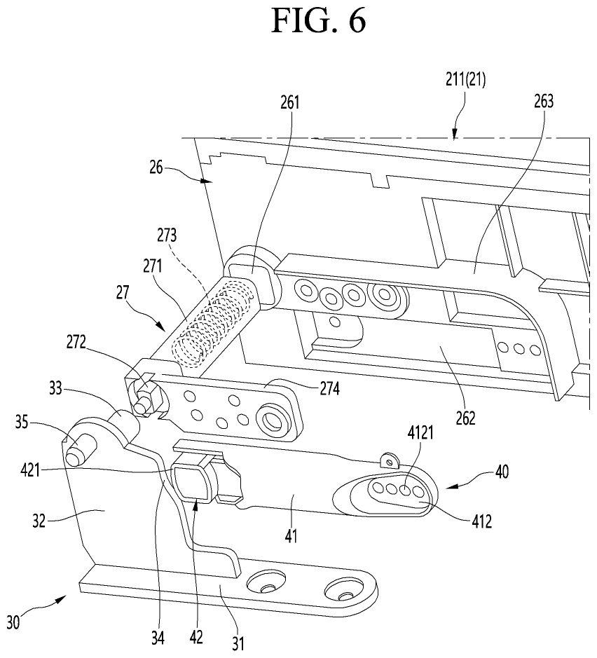

FIG. 5 is a partial perspective view illustrating a state where the door, hinge device, damping device, and auto-closing device are combined, and FIG. 6 is an exploded perspective view illustrating the combined structure of the door, hinge device, damping device, and auto-closing device.

As illustrated, a cap decoration 26 may be provided on the lower surface of the door 21. Additionally, the hinge 30 and the damping device 40 may be mounted on the cap decoration 26. In addition, the cap decoration 26 may be further equipped with an auto-closing device 27.

In detail, the auto-closing device 27 may be mounted on the cap decoration 26. The auto-closing device 27 can automatically close the door 21 by providing torque in the closing direction of the door 21. The auto-closing device 27 may be located on the same extension line as the rotation center of the door 21, and may be combined with the hinge 30 to serve as the rotation axis of the door 21.

The auto-closing device 27 may include a case 271. The case 271 may be inserted and mounted in the case insertion hole 261 on the lower surface of the door 21. In addition, the case 271 can accommodate a spring 273 therein. A shaft coupling part 272 is provided on the lower surface of the case 271, and the shaft coupling part 272 may be connected to the spring 273. The shaft coupling part 272 may be coupled to the hinge shaft 33 when the door 21 is mounted and may rotate together when the door 21 rotates.

The spring 273 has a coil spring structure and can be directly or indirectly connected to the shaft coupling part 272. Accordingly, when the shaft coupling part 272 rotates, the spring 273 may be compressed or tensioned. The spring 273 may act when the door 21 is at the set angle α0 or less and provide elastic force so that the door 21 can be completely closed. In other words, when the door 21 rotates at the set angle or more, the auto-closing device 27 generates torque for a closing operation and can rotate to close the door 21. In addition, the auto-closing device 27 prevents elastic force from being applied in the direction in which the door 21 is rotated to open, thereby preventing repulsive force from being applied when opening.

A case bracket 274 may be formed on the case 271. The case bracket 274 extends laterally from the lower portion of the case 271 and comes into contact with the lower surface of the cap decoration 26, and may be fixed to the cap decoration 26 with screws.

The auto-closing device 27 is only one embodiment of the present disclosure, and various other structures provided on the door 21 or the hinge 30 may be possible to automatically close the door 21.

The hinge 30 may be provided on the front surface of the cabinet 10. The hinge 30 may be formed of a metal material. The hinge 30 may include a hinge bracket 31 and a hinge plate 32. The hinge bracket 31 may be fixedly mounted on the front surface of the cabinet 10 with screws. Additionally, the hinge bracket 31 may be provided with the hinge shaft 33.

The hinge plate 32 may extend in a direction crossing the hinge bracket 31. The hinge plate 32 and the hinge bracket 31 may be molded separately and then combined. Additionally, the hinge plate 32 and the hinge bracket 31 may be formed by bending a single metal plate.

The hinge plate 32 may be formed to have a predetermined thickness, and a contact part 34 with which the damping device 40 is in contact may be formed around the hinge plate 32. The contact part 34 may be formed on a side that forms the thickness of the hinge plate 32 and may also be referred to as a contact part because the contact part is in contact with the damping device 40.

The hinge shaft 33 may protrude upward and be coupled to the shaft coupling part 272. Therefore, when the door 21 rotates in the closing direction, the shaft coupling part 272 may rotate about the hinge shaft 33, and at this time, the clastic force of the spring 273 is applied to the shaft coupling part so that the door 21 can be rotated in the closing direction.

Meanwhile, a hinge shaft 35 protruding downward may be further formed on the lower surface of the hinge plate 32. The hinge 30 may be disposed between the upper door 21 and the lower door 22 to rotatably support the lower end of the upper door 21 as well as the upper end of the lower door 22.

A damping device 40 may be provided on the lower surface of the door 21. As an example, the damping device 40 may be provided in the cap decoration 26. The damping device 40 can reduce the closing speed of the door 21. The damping device 40 may generate a damping force by resistance generated when oil flows inside. Therefore, the damping device 40 may be referred to as a hydraulic damper, oil damper, or damper.

The damping device 40 is disposed on one side of the hinge plate 32 and is selectively in contact with the hinge plate 32 when the door 21 rotates in the closing direction, and can provide damping force to the door 21.

Additionally, the extension line of the damping device 40 in the stroke direction may be located rearward of the hinge shaft 33. In other words, the damping device 40 may be in contact with the hinge plate further rearward than the hinge shaft 33 in the front and rear direction. In other words, the damping device 40 may be disposed closer to the front surface of the cabinet 10 than the hinge shaft 33. Accordingly, the damping force generated by the damping device 40 may act in the opposite direction to the torque generated by the auto-closing device 27. Accordingly, the rotational force (closing force) in the direction in which the door 21 is closed can be attenuated.

A damper mounting part 262 for mounting the damping device 40 may be formed on the cap decoration 26. In addition, the damping device 40 can be mounted on the damper mounting part 262 by screws fastened to both sides of the housing 41.

A shielding part 263 may be further formed on the cap decoration 26. The shielding part 263 may protrude downward from the lower surface of the cap decoration 26 and may shield the damping device 40 from being exposed when viewed from the front.

The door 21 may be rotatably coupled to the hinge 30 while the damping device 40 and the auto-closing device 27 are mounted.

Hereinafter, the damping device 40 will be discussed in more detail with reference to the drawings.

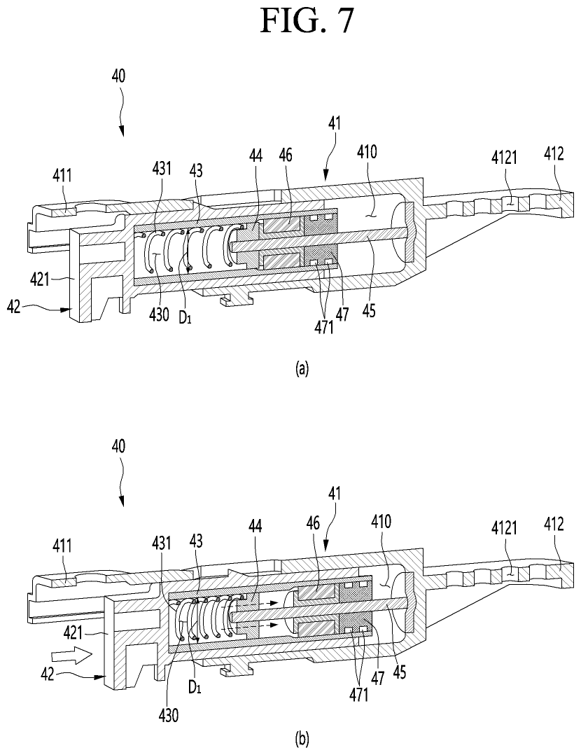

FIG. 7 is a cut-away perspective view illustrating the operating state of the damping device.

As illustrated, the damping device 40 may include a cylinder 43, a piston 44, and a rod 45.

The cylinder 43 is formed in a cylindrical shape with one side open, and may form a buffer space 430 inside which oil is accommodated. The cylinder 43 may be made of a metal material and will not be deformed or damaged even when high pressure is applied to the buffer space 430.

A piston 44 may be movably disposed within the cylinder 43. The inner diameter D1 of the buffer space 430 may be formed to be constant throughout the entire section and may be formed in a shape corresponding to the outer diameter of the piston 44. Accordingly, as the piston 44 moves, the oil in the buffer space 430 can be pressurized.

A rod 45 is connected to the center of the piston 44, and the rod 45 may extend past the opening of the cylinder 43 inside the buffer space 430. The end portion of the rod 45 may be supported inside the housing 41.

The open end portion of the cylinder 43 may be shielded by a sealing cap 47. Additionally, a seal 471 may be provided around the sealing cap 47. A plurality of seals 471 may be disposed in succession.

Additionally, a sponge 46 may be provided inside the cylinder 43. The sponge 46 may be provided between the piston 44 and the sealing cap 47. The sponge 46 is compressed so that the oil passing through the orifice of the piston 44 can be moved when the piston 44 advances, thereby compensating for the volume for the movement of the oil.

The piston 44 may be supported by the elastic member 431 within the buffer space 430. One end of the elastic member 431 may be in contact with the piston 44 and the other end thereof may be in contact with one end of the cylinder 43.

An orifice through which oil moves within the buffer space may be formed in the piston 44. The structure and shape of the orifice can be designed in various ways on the piston 44. As an example, the orifice may be formed by passing through the piston 44. As another example, the orifice may be formed between the piston 44 and the rod 45. The piston 44 is connected to the rod 45 and can move relatively together with the rod 45 within the buffer space 430.

The rod 45 may penetrate the sealing cap 47 and the sponge 46. When the rod is moved, the sealing cap 47 and the sponge 46 may maintain a state of being fixed inside the cylinder 41. In addition, the rod 45 may extend to penetrate the piston 44. When the rod 45 moves, the piston 44 moves together and can pressurize the elastic member 431 and the oil.

The damping device 40 may further include a push member 42 coupled to the cylinder 43. The push member 42 is a portion that comes into direct contact with the hinge 30, and can be formed in various shapes to effectively make contact with the hinge 30. As an example, the push member 42 may be formed in a shape to accommodate the cylinder 43. Additionally, a rounded contact part 421 may be formed on one surface of the push member 42. The opposite side of the contact part 421 is open so that the cylinder 43 can be inserted. The push member 42 may be made of plastic material. Of course, the push member 42 and the cylinder 43 may be formed integrally, or may be formed as a single structure.

The damping device 40 may further include a housing 41. Additionally, the housing 41 may be formed with an accommodation space 410 that is open on one side. In addition, the push member 42 may be accommodated inside the accommodation space 410. The housing 41 is open at one end so that the push member 42 may be inserted. If necessary, the housing 41 may be omitted.

One end of the push member 42 is exposed to the outside of the housing 41, and the other end thereof may maintain a state of being inserted into the accommodation space 410. In addition, when the push member 42 is pressed, the push member 42 can be inserted into the housing 41 while being buffered by the flow of oil inside the damping device 40.

A first coupling part 411 and a second coupling part 412 may be formed at both ends of the housing 41. Screws may be fastened to the first coupling part 411 and the second coupling part 412. A plurality of screw holes 4121 are formed in the second coupling part 412 to adjust the fixing position of the damping device 40.

In (a) of FIG. 7, the push member 42 is illustrated in the most protruding state. This state may be a state where the push member 42 is not in contact with the hinge 30. When the door 21 is closed and the end portion of the push member 42 is in contact with the contact part 34 and is pressed, the push member 42 moves to the right (as seen in FIG. 7) and may be inserted into the housing 41. At this time, the piston 44 may relatively move to the left (as seen in FIG. 7) within the buffer space 430. In addition, the oil in the buffer space 430 flows at a constant flow rate along the orifice, thereby providing a constant oil resistance. Accordingly, the push member 42 moves at a constant speed inside the housing 41, and thus the door 21 is decelerated so that it can be closed at a constant speed.

When the door 21 is completely closed, the damping device 40 is in a state as illustrated in (b) of FIG. 7. In detail, when the door 21 is completely closed, the push member 42 is fully retracted into the housing 41. Additionally, the piston 44 may be moved to the leftmost position within the buffer space 430. In addition, the elastic member 431 may be compressed by the movement of the push member 42.

Therefore, when the door 21 is opened and the push member 42 is separated from the hinge 30, the push member 42 returns to the original position thereof due to the elasticity of the elastic member 431. At this time, oil in the space where the sponge 46 is disposed may flow back to the buffer space 430 through the orifice.

Hereinafter, the hinge 30 and the interaction between the hinge 30 and the damping device 40 will be discussed in more detail with reference to the drawings.

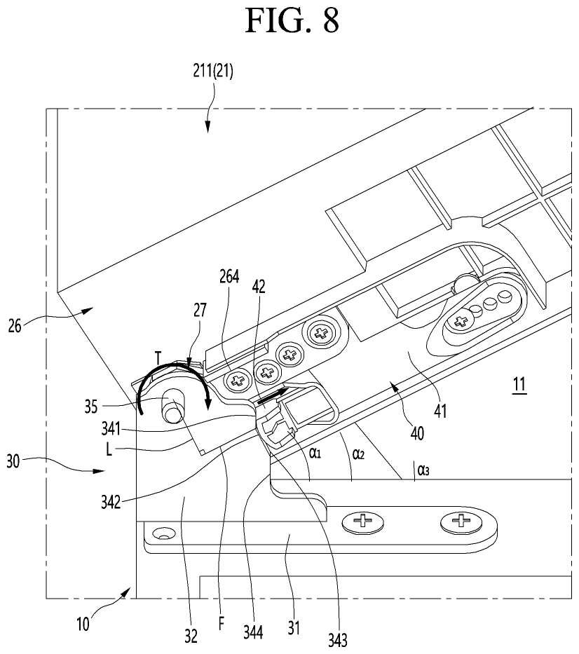

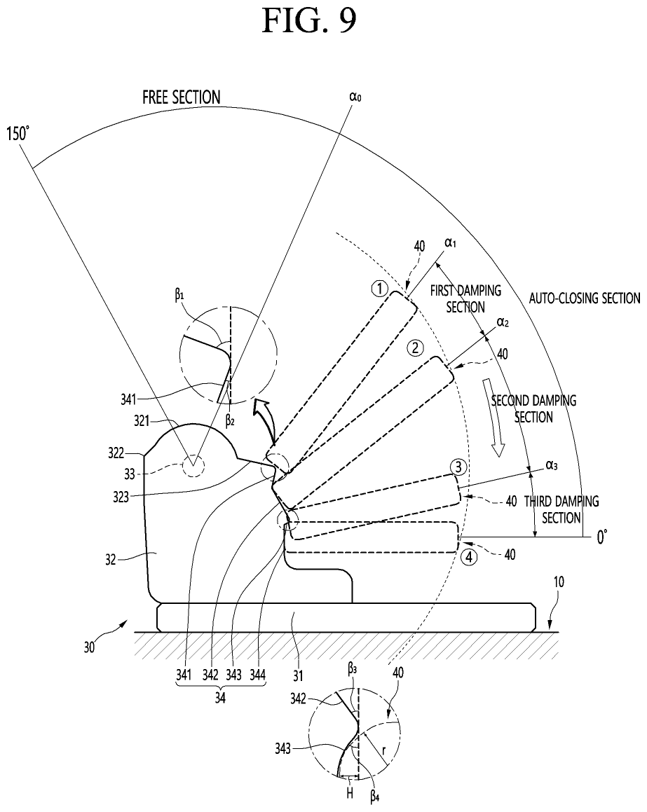

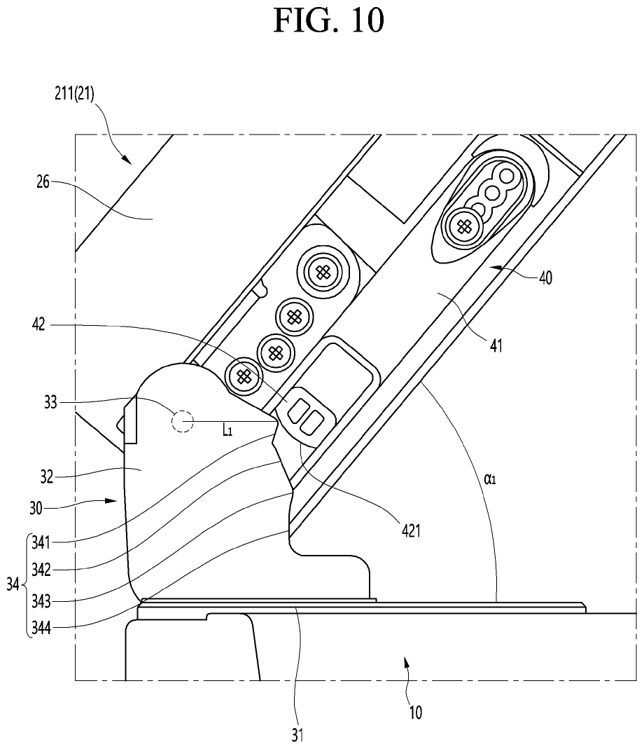

FIG. 8 is a partial perspective view from below illustrating a state where the door is rotated in the closing direction, FIG. 9 is a view illustrating the contact positions of the hinge and damper according to the rotation angle of the door, and FIGS. 10 to 13 are views illustrating changes in the state of the damping device and the door according to the rotation angle of the door.

As illustrated, the hinge 30 may include the hinge bracket 31 and the hinge plate 32. The hinge plate 32 may be formed in a plate shape with a predetermined thickness. Additionally, the contact part 34 may be formed on a portion of the circumferential surface of edge of the hinge plate 32 facing the damping device 40.

The contact part 34 may be formed on a portion of the entire circumferential surface of the hinge plate 32 so that the push member 42 is in contact with the contact part according to the opening/closing angle of the door 21. In addition, the remaining circumferential surface of the hinge plate 32 on which the contact part 34 is not formed may form a section that is not in contact with the damping device 40.

For example, among the circumferential surfaces of the hinge plate 32, from one end perpendicular to the front surface of the cabinet 10 to the other end horizontal thereto, a stop part 322, a rotating part 321, a connecting part 323, and a contact part 34 may be provided. The stop part 322 is a portion that is in contact with the door stopper 264 when the door 21 is completely opened. In addition, the rotating part 321 is a portion that prevents the door from interfering with the door stopper 264 while the door is rotating. In addition, the contact part 34 is a portion that is in contact with the damping device 40 while the door 21 is rotated. In addition, the connecting part 323 is a portion that connects the rotating part 321 and the contact part 34. The connecting part 323 may be omitted according to the shape of the door 21.

Looking at the structure of the contact part 34 in more detail, the contact part 34 may include a first part 341, a second part 342, a third part 343, and a fourth part 344. Additionally, the contact part 34 may be formed so that the distance from the hinge shaft 33 increases from the front end to the rear end. Accordingly, the stroke of the damping device 40 can be increased from the time the damping device contacts the contact part 34 until the door 21 is completely closed. In particular, the stroke of the damping device 40 may be maintained in some sections of the contact part 34, but the overall stroke from the starting point to the ending point of the contact part 34 may be said to increase. Depending on the stroke of the damping device, the damping device may be in a first damping state that provides a first damping force or a second damping state that provides a second damping force less than the first damping force. It is understood that additional damping states with different damping forces may also be provided.

The first part 341 is a portion that the push member 42 first contacts during the process of closing the door 21. The first part 341 may be referred to as a starting part. In addition, the first part 341 may be located at the frontmost part (upper end as seen in FIG. 9) of the contact part 34.

The first part 341 may be inclined by a set angle β2 based on a vertical line passing through an end of the first part 341 and may be directed toward the hinge shaft 33 so as to extend downward. At this time, the set angle β2 may be smaller than the angle β1 between the connecting part 323 and a vertical line passing through the end portion of the first part 341.

The first part 341 may be a section (first damping section) in contact with the push member 42 when the door 21 is opened by the first set angle α1 based on the closed state.

In addition, the center of rotation of the door 21, that is, the distance from the hinge shaft 33 to the starting point of the first part 341 may be equal to the distance from the hinge shaft 33 to the ending point of the first part 341. In other words, a portion of from the starting point to the ending point of the first part 341 may be formed to have the same radius from the hinge shaft 33. Of course, the first part 341 may be formed to connect the starting point of the first part 341 and the ending point of the first part 341 with a straight line. Additionally, the slope between the starting point of the front end and the ending point of the rear end of the first part 341 may be smaller than the slope of the third part 343, which will be described below. Additionally, the length between the starting point and the ending point of the first part 341 may be longer than that of the third part 343.

The second part 342 extends from the ending point of the first part 341 and may be formed rearward (lower when viewed in FIG. 9) of the first part 341. The second part 342 may be formed to provide a damping force by substantially pressing the push member 42 in contact with the push member 42, and may be referred to as a pressing part. For example, the second part 342 may be a section that is in contact with the push member 42 and moves the push member 42 when the door 21 is opened at the second set angle α2.

Additionally, the distance from the hinge shaft 33 to the starting point of the second part 342 may be smaller than the distance from the hinge shaft 33 to the ending point of the second part 342. In other words, the portion of from the starting point to the ending point of the second part 342 may be formed to gradually move away from the hinge shaft 33. The second part 342 may be formed as a straight line between the starting point and the ending point, or at least partially rounded. Accordingly, when the push member 42 moves into contact with the second part 342, the stroke of the damping device 40 increases.

The third part 343 extends from the ending point of the second part 342 and may be formed rearward (lower when viewed in FIG. 9) of the second part 342. The third part 343 may be formed so as not to additionally press the push member 42 even when in contact with the push member 42, and may be referred to as a holding part.

The third part 343 may be a section that is in contact with the push member 42 when the door 21 is opened at the third set angle α3 based on the closed state.

Additionally, the distance from the hinge shaft 33 to the starting point of the third part 343 and the distance from the hinge shaft 33 to the ending point of the third part 343 may be the same. In other words, a portion of from the starting point to the ending point of the third part 343 may be formed to have the same radius from the hinge shaft 33. Of course, the third part 343 may be formed to connect the starting point of the third part 343 and the ending point of the third part 343 with a straight line. Therefore, while the push member 42 passes in contact with the third part 343, the damping device 40 maintains the stroke and the damping force applied to the door 21 does not increase.

The third part 343 is inclined by a set angle β4 with respect to a vertical line passing through an end portion of the third part 343, and may be directed toward the hinge shaft 33 as it extends rearward. At this time, the set angle β4 may be formed to be larger than the angle β3 between the second part 342 and the vertical line.

The fourth part 344 extends from the ending point of the third part 343 and may be formed behind the third part 343 (downward when viewed in FIG. 9). The fourth part 344 may maintain a state of being in contact with the push member 42 when the door 21 is completely closed. At this time, the push member 42 maintains a state of being in close contact with the fourth part 344 by the clastic force of the elastic member 431, and may be referred to as a restraining part.

In addition, the fourth part 344 may form the last section of the contact part 34. For example, the fourth part 344 may be a section that contacts the push member 42 when the door 21 is closed.

The fourth part 344 may be sized to accommodate the end portion of the push member 42. With the end portion of the push member 42 accommodated in the fourth part 344, the third part 343 may contact one edge of the push member 42. Accordingly, when the door 21 is closed, the push member 42 can maintain a state of being stably accommodated in the space formed by the third part 343 and the fourth part 344.

In addition, the fourth part 344 is recessed based on the protruding third part 343, and at this time, the recessed depth H of the fourth part 344 may be formed smaller than the curvature radius r of the corner of the push member 42. Therefore, when the door 21 is opened, the damping device 40 can be moved naturally without an increase in stroke in the process of moving from the fourth part 344 to the third part 343. In other words, when opening the door 21, the door 21 can be opened with less force without the reaction force caused by the damping device 40.

Meanwhile, the contact part 34 may be composed of only the second part 342, the third part 343, and the fourth part 343. In addition to the second part 342, third part 343, and fourth part 343, the contact part 34 may further include another section that can be in contact with the push member 42.

Assuming that the fully closed state of the door 21 is 0° relative to the front of the cabinet 10, the door 21 may be approximately an angle of 130° to 150° from the front surface of the cabinet 10 in the fully open state. In addition, the section in which the door 21 rotates can be divided into a free section and an auto-closing section.

The free section may be a section in which the door 21 is rotated from a fully open state to a set angle α0 in a closed direction. As an example, the set angle may be an angle of 40° to 50°. At this time, the door 21 can be freely rotated according to the user's manipulation without the force of the auto-closing device 27 and the damping device 40 being applied. Accordingly, the user can freely rotate and stop the door 21 in a free section. Typically, a user can store food in the free section after opening the door 21.

The auto-closing section may be a section in which the door 21 is rotated at the set angle α0 until the door is completely closed. In the auto-closing section, the door 21 may be automatically closed by the torque provided by the auto-closing device 27. In other words, when the user rotates the door 21 at the set angle α0 or less, the auto-closing device 27 operates and rotates the door 21 until the door 21 is completely closed.

The auto-closing section may overlap with a damping section where a damping force is applied from the damping device 40. In addition, in the damping section, the damping device 40 may come into contact with the contact part 34 to generate a damping force.

The damping device 40 may be located at a position spaced apart from the hinge shaft 33 by a vertical distance L. Additionally, the damping device 40 may be disposed parallel to the longitudinal direction of the left and right sides of the door 21. The vertical distance between the damping device 40 and the hinge shaft 33 according to the opening angle of the door 21 may be kept the same. The damping device 40 increases the stroke thereof by being in contact with the contact part 34 within the damping section and provides a damping force F. Therefore, when the damping device 40 operates, torque is applied in a direction opposite to the direction of the torque T provided by the auto-closing device 27. Accordingly, the door 21 can be closed smoothly by the damping force of the damping device 40 applied within the damping section.

In detail, when the door 21 is closed at the first set angle α0 or less, the auto-closing device 27 starts operating. The auto-closing device 27 operates at an angle of approximately 50° to 0° based on the closed state of the door 21, so that the door 21 can be automatically closed without user intervention. When the auto-closing device 27 starts operating, the push member 42 and the hinge plate 32 may not be in contact with each other.

When the door 21 reaches the first set angle α1, the push member 42 may come into contact with the first part 341 of the contact part 34. Due to the inclination direction and angle of the first part 341, the stroke of the damping device 40 moving along the first part 341 may be maintained or slightly increased. Accordingly, the damping device 40 can alleviate oil impact initially generated due to the operation characteristics of the oil damper due to contact and movement with the first part, and can smooth the subsequent oil flow. The damping device 40 may maintain a minimum stroke before contact with the second part 342.

In this way, the first damping section where the push member 42 passes through the first part 341 can be viewed as a preparation stage for the actual action of damping force and deceleration of the door 21. (States \textcircled{1} in FIG. 9 and FIG. 10)

When the door 21 is further rotated and reaches the second set angle α2, the push member 42 may come into contact with the contact part 34 to provide a damping effect. For example, the second set angle α2 may be approximately 30°. In other words, during the process of closing the door 21 by the auto-closing device 27, the push member 42 may start to be in contact with the second part 342. The push member 42 is in contact with the second part 342 at a position spaced apart from the hinge shaft 33 by a second set distance L2. At this time, the second set distance L2 is formed to be longer than the first set distance L1, and thus the stroke of the damping device 40 is increased.

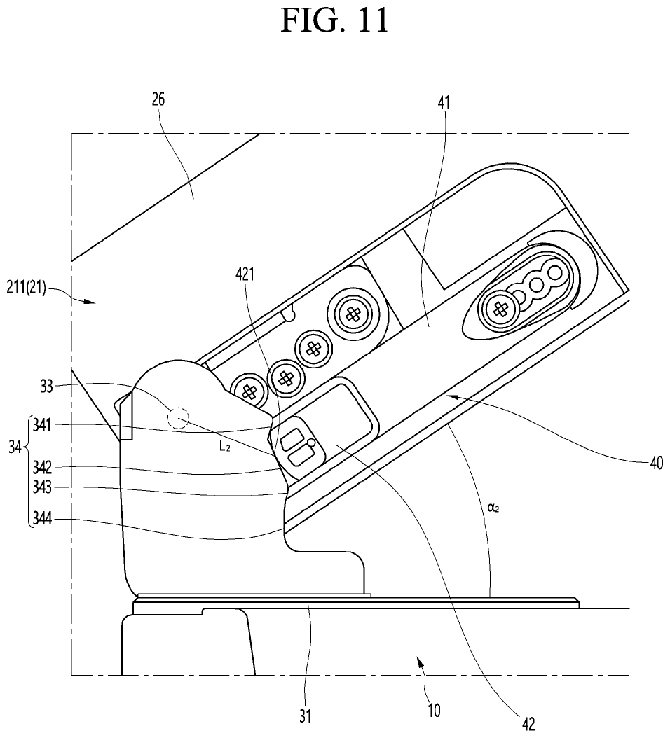

Accordingly, the damping device 40 can provide a constant damping force, and the door 21 can be closed while being decelerated at a constant speed within the second damping section (states \textcircled{2} of FIG. 9 and FIG. 11). The second damping section is a section in which the change in stroke of the damping device is greatest. In other words, among the entire sections of the contact part 34, the second damping section is the section in which the difference between the distance from the hinge shaft 33 to the upper end and the lower end of the second part 342 is the largest. Accordingly, the actual damping force and deceleration of the door 21 can occur while the damping device 40 is in contact with and moves the second part 342.

In addition, when the door 21 reaches the third set angle α3, the push member 42 is in contact with the third part 343 of the contact part 34 and may move while maintaining the stroke of the damping device 40. For example, the third set angle α3 may be approximately 5° to 7°.

Due to the inclination direction and angle of the third part 343, the stroke of the damping device 40 moving along the third part 343 may be maintained constant or slightly increased. The push member 42 is in contact with the third part 343 at a position separated from the hinge shaft 33 by a third set distance L3, and at this time, the third set distance L3 may be equal to the distance at the lower end of the second set distance L2. Of course, the third set distance L3 may be slightly longer than the lower end of the second set distance L2.

In other words, when the door 21 rotates at the third set angle α3 or less, the push member 42 passes through the second part 342 and enters the third part 343. While the push member 42 passes through the third part 343, the push member 42 is no longer pressed, and the damping device 40 can maintain the stroke.

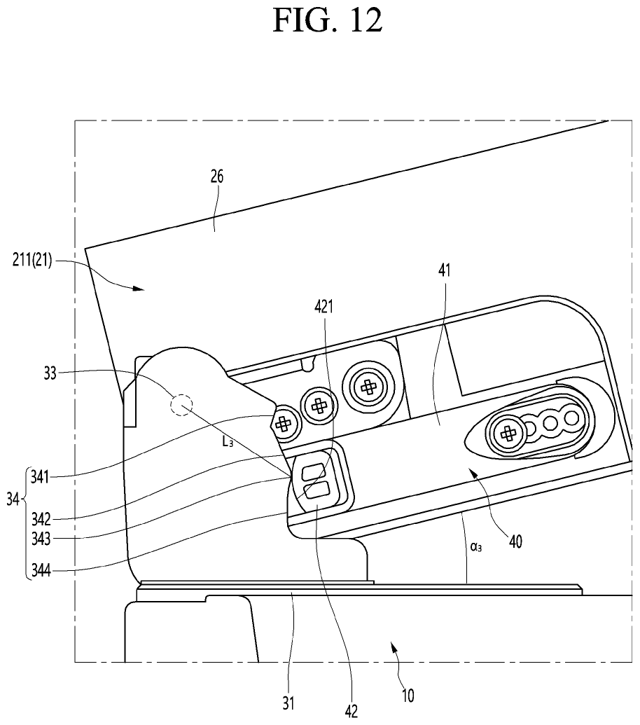

Accordingly, no substantial damping force is applied to the door 21 or a smaller damping force is applied, and the door 21 can be closed by the torque provided by the auto-closing device 27. Since no damping force is applied to the third damping section, the third damping section can be referred to as a non-damping section. (states \textcircled{3} in FIG. 9 and FIG. 12)

When the door 21 is completely closed, the push member 42 comes into contact with the fourth part 344. The push member 42 may be in contact with the fourth part 344 at a position spaced apart from the hinge shaft 33 by a fourth set distance L4. When the door 21 is completely closed, the end portion of the push member 42 may be in contact with a position adjacent to the starting point of the fourth part. At this time, the fourth set distance L4 may be equal to or slightly longer than the third set distance L3.

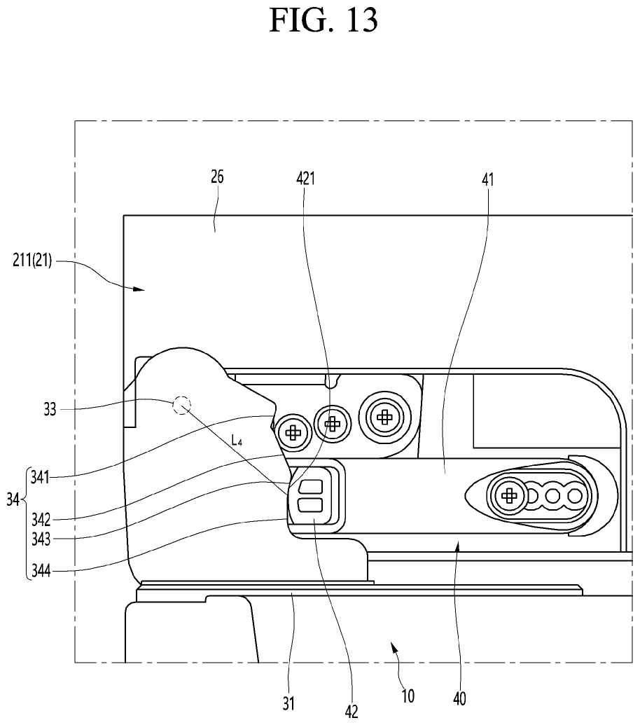

The end portion of the push member 42 is maintained in close contact with the fourth part 344 and is restrained by the protruding third part 343, and, by a repulsive force at the moment when the door 21 is closed, the door 21 can be prevented from reopening or shaking (states \textcircled{4} in FIG. 9 and FIG. 13).

In this way, so that the door 21 can be closed more smoothly, the contact part 34 may be composed of multiple sections that play different roles according to the rotation angle of the door 21. Since the damping device 40 provides a damping force based on oil resistance, compared to a spring-structured damper, the door 21 can be closed at a constant speed even under various weight states and various closing operation conditions. In particular, in a situation where the door 21 is closed at a high speed in a free section, the rotational speed of the door 21 is reduced by the damping force of the damping device 40, and the impact at the moment when the door 21 is closed is reduced and thus it is ensured that the door 21 closes smoothly and accurately.

Hereinafter, the opening and closing operation of the door 21 of the refrigerator according to an embodiment of the present disclosure having the above structure will be described in more detail with reference to the drawings.

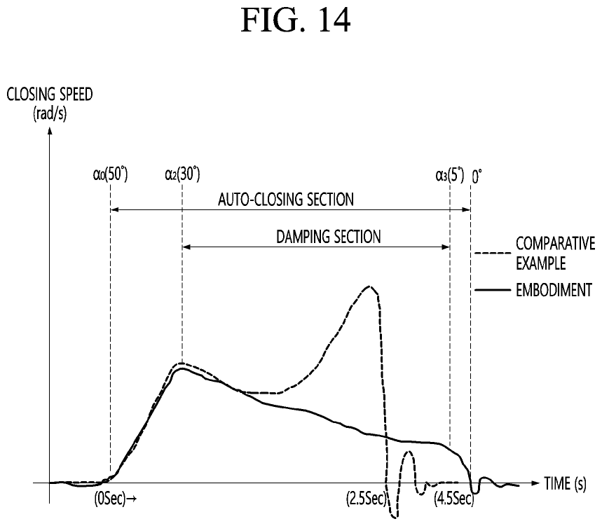

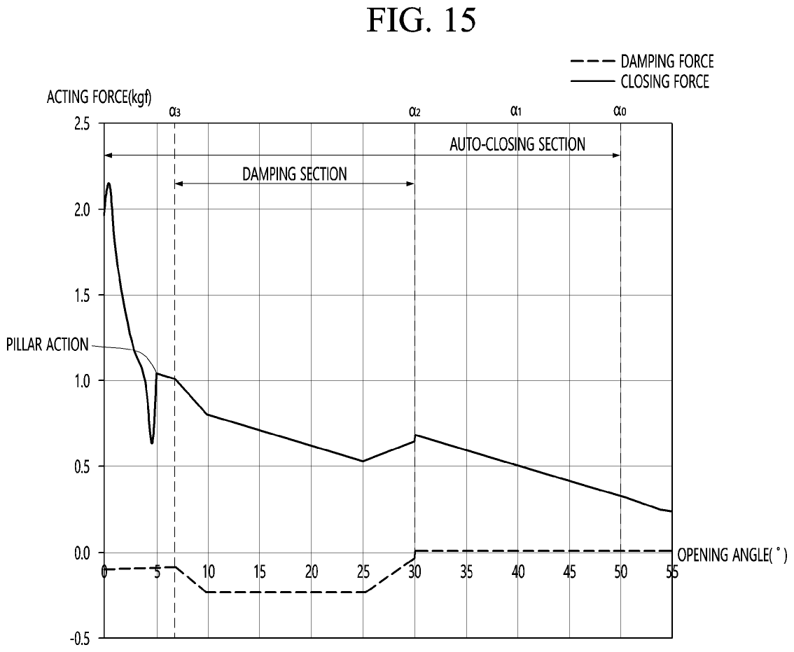

FIG. 14 is a graph illustrating the change in closing speed over time of the door according to the first embodiment of the present disclosure and the door according to the comparative example, and FIG. 15 is a graph illustrating changes in damping force and closing force according to the opening angle of the door according to the first embodiment of the present disclosure.

As illustrated, the comparative example is a refrigerator with a conventional door without a damping device. In the above comparative example, the door is closed by the operation of the auto-closing device. The door closes quickly as the overall closing speed increases, and in particular, the speed of the door rapidly increases and closes due to inertia just before the door closes. Therefore, the door may generate a large noise due to impact at the moment when the door is closed, and the door may be opened again due to a reaction force due to the impact when the door is closed. This problem becomes more serious when the door becomes heavier.

Meanwhile, in an embodiment of the present disclosure, when the door 21 is rotated and reaches the set angle α0, the auto-closing device 27 is operated to increase the closing speed of the door 21 and thus the door 21 can be automatically rotated.

The door 21 is closed only by the torque of the auto-closing device 27 until the door reaches the first set angle α1, and when the door reaches the first set angle α1, the damping device 40 comes into contact with the first part 341. At this time, the first part 341 may not increase or minimize the stroke of the damping device 40, thereby alleviating the momentary impact applied to the oil inside the damping device 40.

When the door 21 is rotated to the second set angle α2, the damping force is increased and maintained by contact between the damping device 40 and the second part 342, and the door 21 closes in a decelerated state. In other words, the second damping section between the second set angle α2 and the third set angle α3 may be a substantial damping section.

In addition, when the door 21 is rotated at the third set angle α3 or less, the damping device 40 passes through the third part 343. At this time, the door 21 has already been sufficiently decelerated before entering the third part 343, and no damping force is applied, so proper closing by the auto-closing device 27 can be guaranteed.

In particular, even if the closing force temporarily decreases due to friction generated as the pillar 25 is inserted into the guide groove 111a, it can be guaranteed that the sliding of the door 21 does not occur and the door 21 is effectively closed.

Accordingly, the third set angle α3 may be an angle just before the guide protrusion 252 of the pillar 25 is inserted into the guide groove 111a. For example, if the angle of the door 21 when the guide protrusion 252 is inserted into the guide groove 111a is 5°, the third set angle α3 may be 5° to 7°. In other words, the pillar 25 may be operated while the push member 42 is in contact with the third part 343.

In addition, when the push member 42 moves past the third part 343 to the fourth part 344, the door 21 can be completely closed in a state where no additional damping force is applied from the damping device 40.

Meanwhile, the present disclosure may have various other embodiments in addition to the above-described embodiments. The second embodiment of the present disclosure is characterized in that the damping device has a multi-stage damping structure.

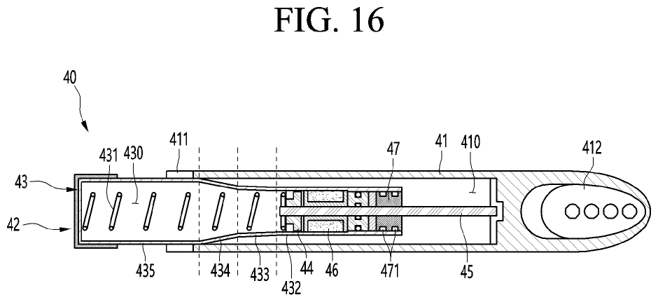

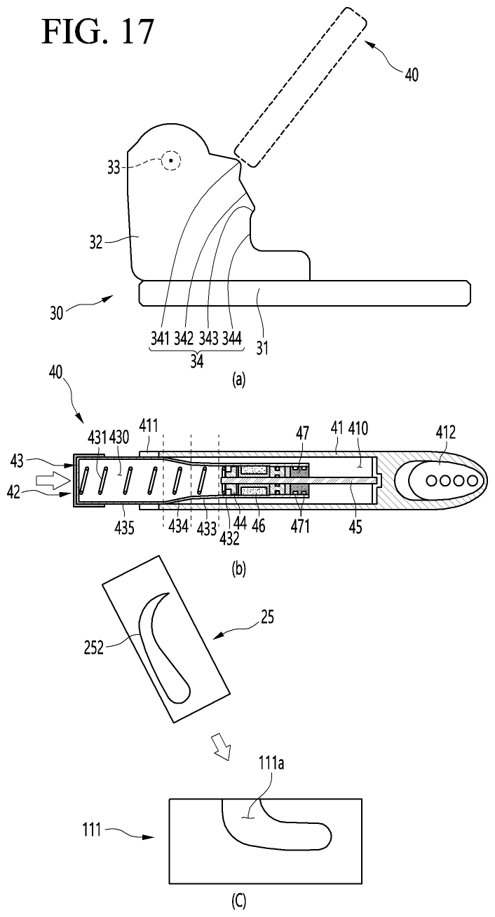

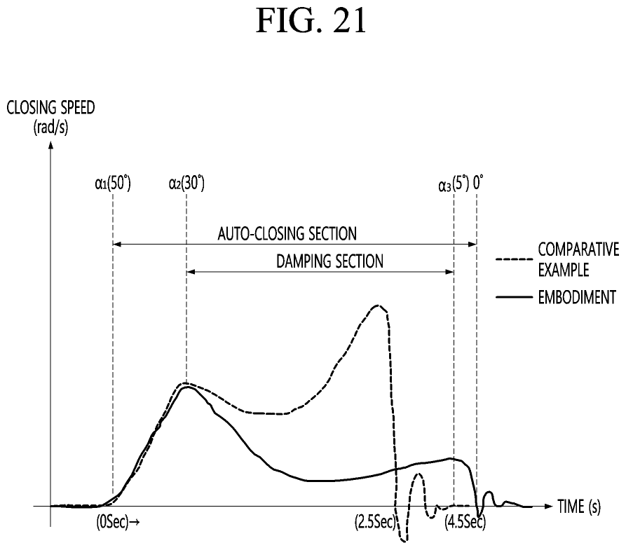

FIG. 16 is a cross-sectional view illustrating the damping device and the operating state thereof according to the second embodiment of the present disclosure, FIGS. 17 to 20 are views illustrating the position of the damping device, the internal state of the damping device, and changes in the state of the pillar according to the rotation of the door, and FIG. 21 is a graph illustrating the change in closing speed over time of the door equipped with the damping device and the door of a comparative example.

As illustrated, the damping device 40 of the second embodiment of the present disclosure may include a cylinder 41, a piston 44, and a rod 45.

The cylinder 43 may form a buffer space 430 in which oil is accommodated, and one side may be open. In addition, one open surface may be shielded by a scaling cap 47. Additionally, a seal 471 may be provided around the sealing cap 47 to prevent oil leakage.

Additionally, a sponge 46 may be provided in the buffer space 430. The rod 45 penetrates the sealing cap 47 and the sponge 46 and may extend from the inside of the buffer space 430 to the outside. At this time, the scaling cap 47 and the sponge 46 may maintain a fixed position in the cylinder 41. In addition, a piston 44 that moves together with the rod 45 may be provided at the end portion of the rod 45.

A spring 431 may be provided inside the buffer space 430 between the piston 44 and the cylinder 41. Both ends of the spring 431 support the inner surface of the cylinder 43 and the piston 44, and may be compressed when the piston 44 moves. Therefore, when no external force is provided to the cylinder 41, the piston 44 can be returned to the initial state thereof by the spring 431.

The damping device 40 may further include a housing 41. The housing 41 forms an accommodation space 410 whose one side is open, and at least a portion of the cylinder 43 may be accommodated inside the accommodation space 410.

A first coupling part 411 and a second coupling part 412 are formed on both sides of the housing 41 and can be mounted on the lower surface of the door 21. Accordingly, the damping device 40 can provide a damping force to the door 21 by being in contact with the contact part 34 of the hinge 30 when the door 21 is closed.

In addition, the damping device 40 may further include a push member 42. The push member 42 may be coupled to the cylinder 43. The cylinder 43 and the push member 42 may be formed as one piece.

Meanwhile, the inner surface of the cylinder 43 may include a first damping part 432. The damping force generated when the piston moves within the first damping part 432 may be referred to as a first damping force.

Additionally, the cylinder may include a second damping part 433 extending from the first damping part 432. The inner diameter of the second damping part 433 may be larger than the inner diameter of the first damping part 432. The inner diameter of the second damping part 433 may increase as the distance from the first damping part 432 increases. In other words, the second damping part 433 may be inclined with respect to the first damping part 432. The damping force generated when the piston moves within the second damping part 433 may be referred to as the second damping force. The second damping force is smaller than the first damping force.

The cylinder may further include a third damping part 434 extending from the second damping part 433. The inner diameter of the third damping part 434 may increase as the distance from the second damping part 433 increases. In other words, the third damping part 434 may be inclined with respect to the second damping part 433. At this time, the inclination angle of the third damping part 434 with respect to the first damping part 432 may be greater than the inclination angle of the second damping part 433 with respect to the first damping part 432. The damping force generated when the piston moves within the third damping part 434 may be referred to as a third damping force. The third damping force is smaller than the second damping force.

The cylinder may further include a fourth damping part 435 extending from the third damping part 434. The inner diameter of the fourth damping part 435 may be larger than or equal to the inner diameter of the third damping part 434. The inner diameter of the fourth damping part 435 may be constant in the longitudinal direction or may increase as the distance from the third damping part 434 increases. The damping force generated when the piston 44 moves within the fourth damping part 435 may be referred to as a fourth damping force. The fourth damping force is smaller than the third damping force.

In the present embodiment, as the inner diameter of the cylinder 43 becomes larger, the amount of oil flowing through the flow path (orifice) formed between the inner circumferential surface of the cylinder 43 and the piston 44 increases, thereby reducing the damping force. Therefore, in the case of the present embodiment, a damping force is generated in a certain section where the door 21 is closed, and the generated damping force can be gradually reduced.

In the present embodiment, the cylinder 43 includes four portions with different inner diameters as an example, but it should be noted that the idea of the present disclosure is that the cylinder 43 includes a plurality of portions with different inner diameters. Additionally, the lengths of each of the damping parts may be different from each other and may be determined to appropriately distribute the damping force.

The damping device 40 sequentially provides multiple stages of damping force, thereby gradually reducing the damping force in the process of closing the door 21, allowing the door 21 to close more smoothly. In addition, in the final section where the door 21 is completely closed, the damping force is set to the lowest to ensure that the door 21 can be closed more reliably.

Hereinafter, the position of the damping device and changes in the state of the inside of the damping device and the pillar while the door 21 to which the damping device 40 of the second embodiment of the present disclosure described above is applied is closed will be described.

As illustrated, when the door 21 is rotated to the set angle α0, the auto-closing device 27 operates. In addition, the door is closed as the closing force of the door 21 gradually increases due to the torque provided by the auto-closing device 27 and the closing speed of the door 21 increases.

As illustrated in FIG. 17, when the door 21 reaches the first set angle α1, the damping device 40 starts to be in contact with the hinge 30. In other words, the damping device 40 may be in contact with the first part 341. At this time, in the first part 341, the stroke of the damping device 40 is maintained or slightly increased only to alleviate the oil impact during the initial operation of the damping device 40 and not to substantially increase the damping force in order to substantially reduce the deceleration of the door 21.

Accordingly, the cylinder 43 may be in the most protruding state, which is the same as the state where the damping device 40 is not in contact with the hinge 30. In other words, the piston may be located on the first damping part 432. Then, the pillar 25 maintains the folded state and is separated from the pillar guide 111.

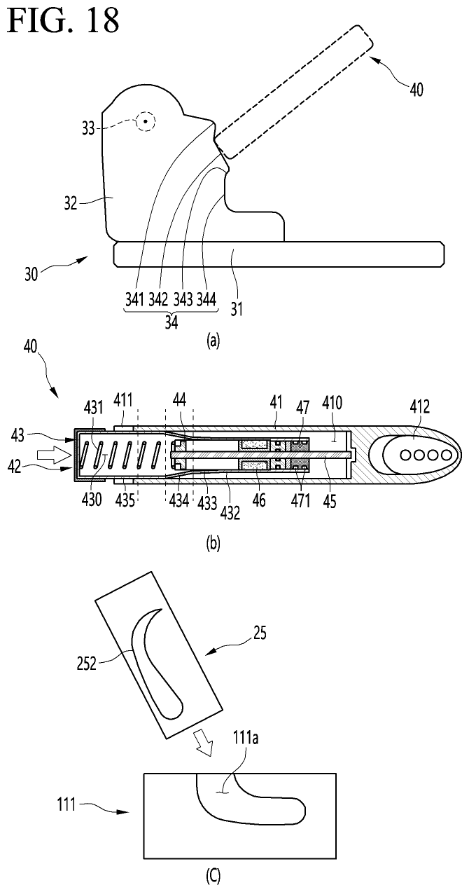

As illustrated in FIG. 18, when the door 21 is closed at the second set angle α2 or less, the damping device 40 is in contact with the second part 342. Additionally, the stroke of the damping device 40 increases as the damping device moves along the second part 342, and a constant damping force can be continuously applied to the damping device 40. Accordingly, the total closing force applied to the door 21 increases from a state of being reduced by the damping force provided. In other words, the door 21 may be closed while rotating at a reduced speed equal to the damping force provided by the damping device 40.

At this time, the piston 44 of the damping device 40 may pass through the first damping part 432 to the third damping part 434, and provide a gradually reduced damping force to the door 21. Accordingly, the door 21 can rotate while decelerating. In addition, while the damping device 40 and the second part 342 are moved in contact with each other, the damping force provided to the door 21 is variable, so that the door 21 is decelerated at a constant rate and closes more smoothly.

In addition, as the door 21 rotates, the pillar 25 becomes closer to the pillar guide 111, but the pillar 25 still maintains the folded state. In addition, the pillar 25 remains a state of being separated from the pillar guide 111.

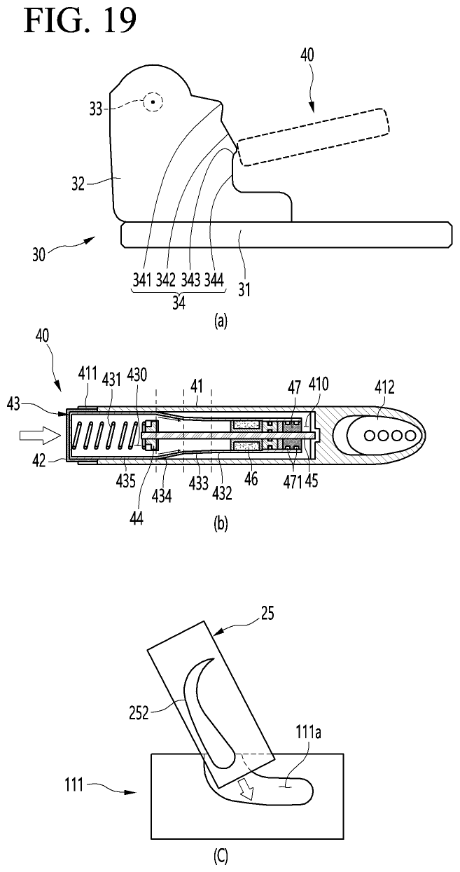

As illustrated in FIG. 19, when the door 21 is rotated to the third set angle α3, the damping device 40 is in contact with the third part 343. When the damping device 40 is in contact with the third part 343, no additional damping force is provided to the damping device 40.

Additionally, the piston 44 is located in the fourth damping part 435, and no damping force is applied or a minimal damping force is provided to the door 21. Accordingly, the rotation speed of the door 21 may be temporarily increased.

In addition, at this time, the pillar 25 can be inserted into the pillar guide 111 and operated. In other words, the guide protrusion 252 of the pillar 25 moves along the guide groove 111a, and despite the friction force generated at this time, the damping force provided by the damping device 40 is minimized, and thus the door 21 may be closed and the pillar 25 may be unfolded by the torque of the auto-closing device 27.

When the door 21 is rotated at the third set angle α3 or less, the door 21 is closed smoothly because no additional damping force is applied. In particular, the closing of the door at an appropriate speed is ensured despite friction generated during the operation of the pillar 25. In addition, the door 21 is sufficiently decelerated to reduce the repulsive force at the moment of closing.

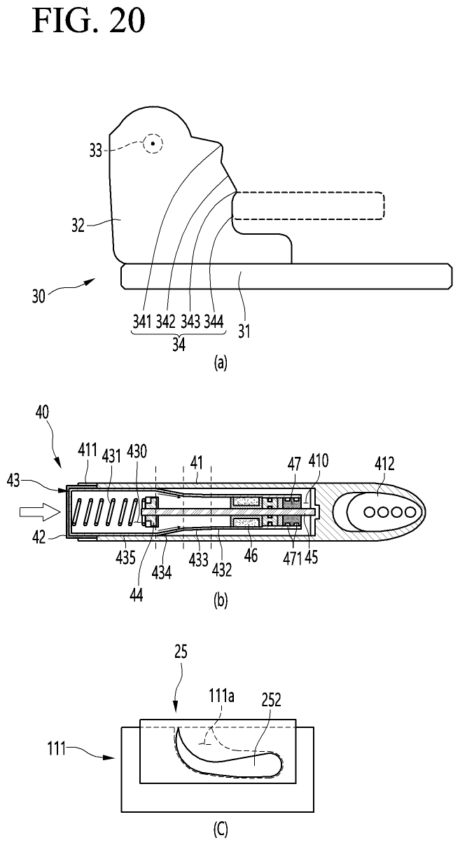

As illustrated in FIG. 20, when the door 21 is completely closed, the damping device 40 is in contact with the fourth part 435. At this time, the stroke of the damping device 40 does not increase, and the piston 44 maintains the position thereof in the fourth damping part 435. Then, the pillar 25 is fully unfolded, allowing airtightness between the doors 211 and 212 on both sides.

Of course, the damping device 40 of the second embodiment having a multi-stage damping structure can be applied not only to the hinge 30 having the structure described above, but also to the hinges of various embodiments that will be described below.

Meanwhile, the present disclosure may have various other embodiments in addition to the above-described embodiments. A third embodiment of the present disclosure is characterized in that a damping device is provided on a door without a pillar.

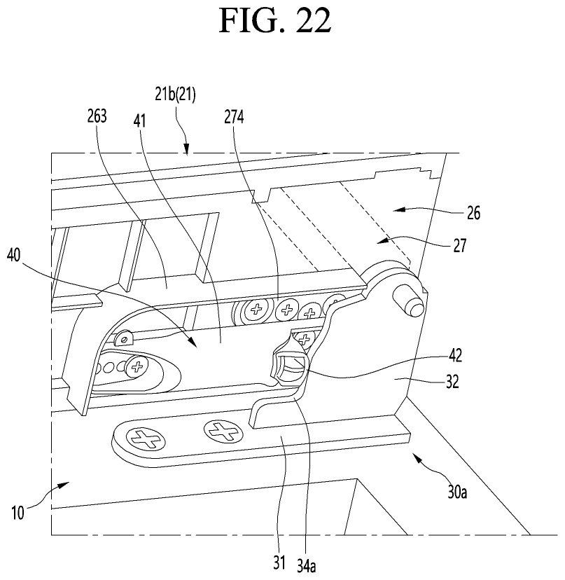

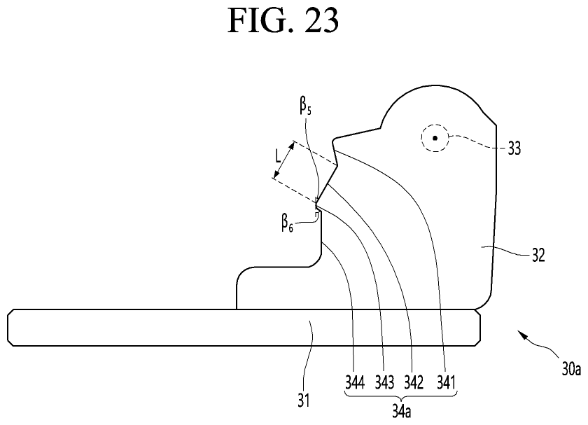

FIG. 22 is a partial perspective view illustrating a door according to a third embodiment of the present disclosure, and FIG. 23 is a bottom view illustrating the hinge of the door.

As illustrated in the drawing, the door 21 of the refrigerator 1 according to the third embodiment of the present disclosure may be the door 21 without the pillar 25 of the above-described embodiment. For example, the door 21 may be the right door 212. As another example, the door 21 may be a refrigerator door that closes one storage space with one door.

The door 21 may be rotatably mounted by the hinge 30a. The hinge may include a hinge bracket 31 and a hinge plate 32. Additionally, the hinge plate 32 may be provided with a hinge shaft 33. In addition, a contact part 34a in contact with the damping device 40 may be formed on the circumferential surface of the hinge plate 32. The contact part 34a may include the first part 341, the second part 342, the third part 343, and the fourth part 344. At this time, the first part 341 may be omitted.

Meanwhile, since the door 21 in the present embodiment is not provided with a pillar 25, the length L of the second part is made longer so that the door 21 can be closed more smoothly, thereby making the deceleration section longer. In addition, in order to shorten the section of the third part 343 that is accelerated just before the door 21 is closed, the angle β6 between the vertical line passing through the third part 343 and the third part 343 may be made larger.

Additionally, in the case of the door 21 not provided with the pillar 25, the third part 343 may be omitted. Since resistance is not generated by the pillar 25, if the torque of the auto-closing device 27 is sufficiently greater than the damping force of the door damping device 40, the third part 343 can be omitted and the closing of the door 21 can be guaranteed.

Of course, the hinge 30a may be formed to have the same structure as the above-described embodiment. In this case, it may also be possible to use the hinges 30 and 30a on both the left and right sides in common.

The door 21 may include the auto-closing device 27. Additionally, the damper mounting part 262 is formed on the cap decoration 26 forming the lower surface of the door 21, and the damping device 40 may be mounted on the damper mounting part 262. Additionally, the shielding part 263 may be formed on the cap decoration 26.

The damping device 40 may include a housing 41 and a push member 42. In addition, although the internal structure of the damping device 40 is not illustrated, either of the damping devices 40 of the first embodiment or the second embodiment described above may be used.

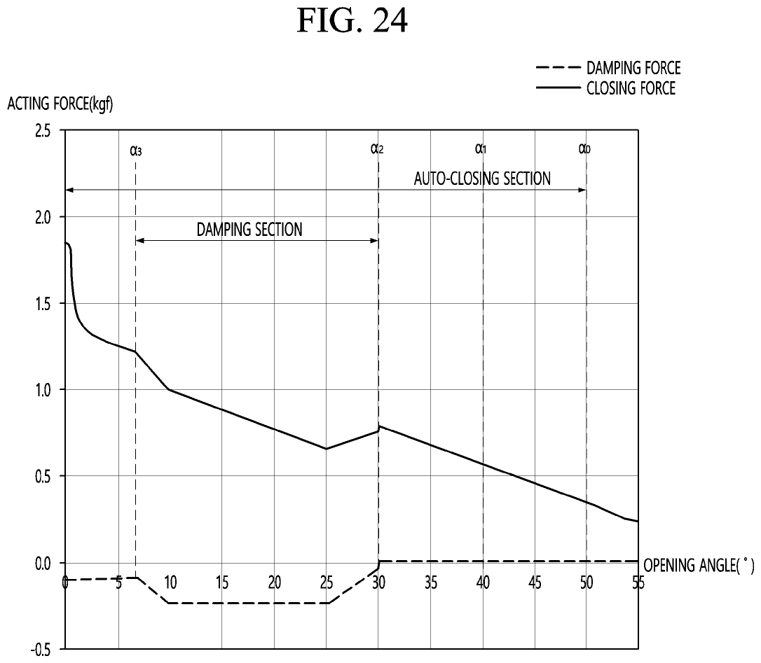

FIG. 24 is a graph illustrating changes in damping force and closing force according to the rotation angle of the door.

As illustrated, when the door 21 is rotated by the set angle α0, the auto-closing device 27 operates, and the closing force of the door 21 gradually increases.

In addition, when the door 21 passes the first set angle α1 and closes at the second set angle α2 or less, the damping device 40 moves into contact with the contact part 34a, The damping force of the damping device 40 can be increased and maintained. Accordingly, the total closing force applied to the door 21 increases from a state of being reduced state by the increased damping force. In other words, the door 21 may be closed while rotating at a reduced speed equal to the damping force provided by the damping device 40.

In addition, when the door 21 is closed at the third set angle α3 or less, the damping device 2 does not provide additional damping force. Accordingly, the damping device 40 does not reduce the closing force of the door 21, thereby ensuring that the door 21 closes at an appropriate speed at the last moment.

Meanwhile, the present disclosure may have various other embodiments in addition to the above-described embodiments. The fourth embodiment of the present disclosure is characterized in that in a door not equipped with an auto-closing device, the door is closed while being decelerated by contact between the damping device and the hinge.

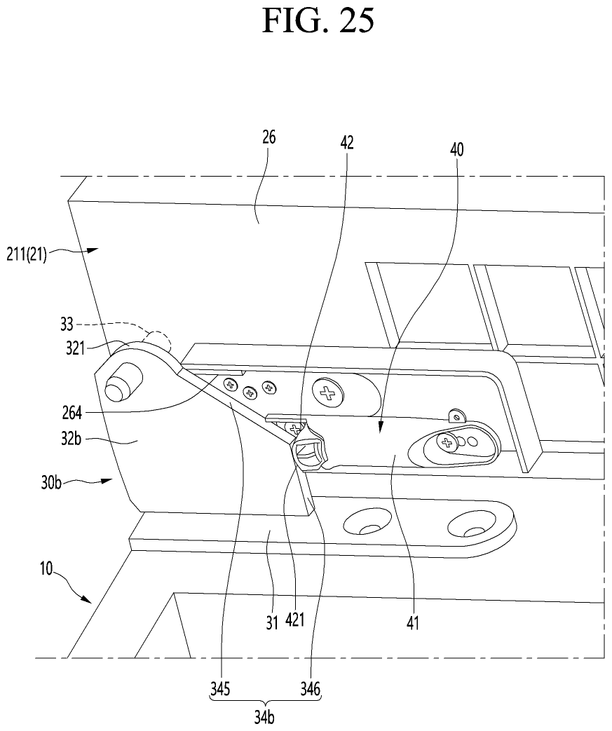

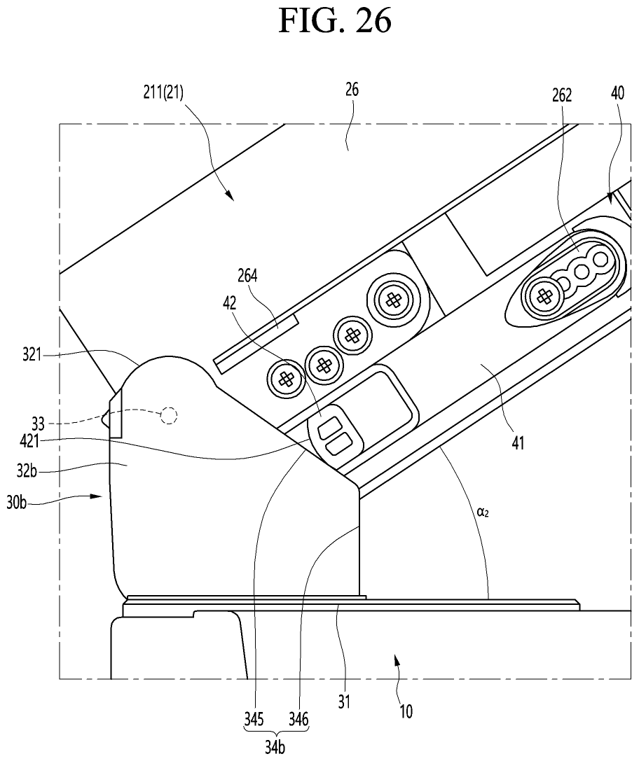

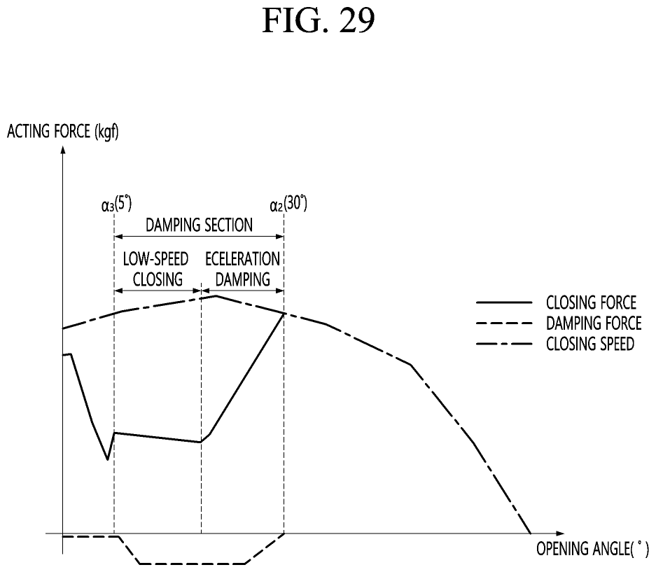

FIG. 25 is a partial perspective view illustrating a door according to a fourth embodiment of the present disclosure, FIGS. 26 to 28 are views illustrating changes in the state of the damping device and the door according to the rotation angle of the door, and FIG. 29 is a graph illustrating changes in damping force and closing force and changes in closing speed according to the rotation angle of the door.

As illustrated in the drawing, the door 21 of the refrigerator 1 according to the fourth embodiment of the present disclosure can be rotatably mounted by a hinge 30b. At this time, the door may be the left door 211 on which the pillar 25 is mounted.

The hinge 30b may include a hinge bracket 31, a hinge plate 32b, and the hinge shaft 33. Additionally, a contact part 34b may be formed on the circumferential surface of the hinge plate 32b. A rotating part 321 is formed on the circumference of the hinge plate 32 to avoid interference with the door stopper 264, and the contact part 34b may extend from an end portion of the rotating part 321. The contact part 34b may include a pressing part 345 and a restraining part 346.

The pressing part 345 extends from the end portion of the rotating part 321 and may be formed to be inclined. The pressing part 345 comes into contact with the damping device 40 in the process of closing the door 21, and presses the push member 42 of the damping device 40 to increase the stroke. The pressing part 345 may be formed to become farther away from the damping device 40 as the pressing part extends forward of the hinge plate 32b. As an example, the pressing part 345 may be formed to be inclined or rounded.

The restraining part 346 extends from the end portion of the pressing part 345 to the hinge bracket 31. The restraining part 346 may extend in a direction crossing the pressing part 345. In addition, when the door 21 is completely closed, the damping device 40 passes through the pressing part 345 and is in contact with the restraining part 346.

In addition, the damper mounting part 262 is formed on the cap decoration 26 of the door 21, and the damping device 40 can be mounted. The damping device 40 may include a housing 41 and a push member 42. Additionally, the damping device 40 may have a multi-stage damping structure similar to the damping device 40 of the second embodiment described above.

In other words, as in the second embodiment described above, the damping device 40 may be formed with the first damping part 432 and the second damping part 433. Therefore, during the process of closing the door 21, the piston 44 provides a relatively large damping force as it passes through the first damping part 433, and provides a relatively small damping force as it passes through the second damping part 434, and thus the door 21 can be closed stably after being decelerated to an appropriate speed. Additionally, the damping device 40 may include a plurality of damping parts 432, 433, 434, and 435.

The door 21 is rotated by the user's rotation operation without external force acting on the door 21 until the door 21 reaches the set angle.

In addition, when the door 21 is closed at the first set angle α1 or less, the damping device 40 moves while being in contact with the pressing part 345, as illustrated in FIG. 26. In addition, the stroke of the damping device 40 increases due to pressure, and a damping force can be applied. Accordingly, the total closing force applied to the door 21 is reduced by the increased damping force. In other words, the door 21 can be rotated while being decelerated by the damping force provided by the damping device 40.

In detail, the piston 44 of the damping device 40 passes through the first damping part 433 until the door 21 rotates and reaches the second set angle α2 and can provide the damping force to the door 21 to reduce the closing force of the door 21.

In addition, when the door 21 passes the second set angle α2 and approaches the third set angle, the piston 44 of the damping device 40 passes the second damping part 434, and substantially no, or low, damping force is provided to the door 21. Accordingly, the closing force applied to the door 21 increases, and the door 21 can be closed more easily at a lower rotation speed.

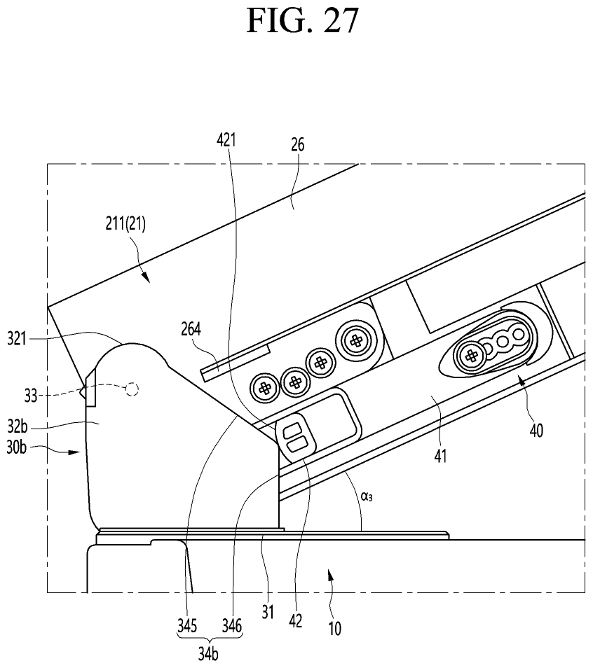

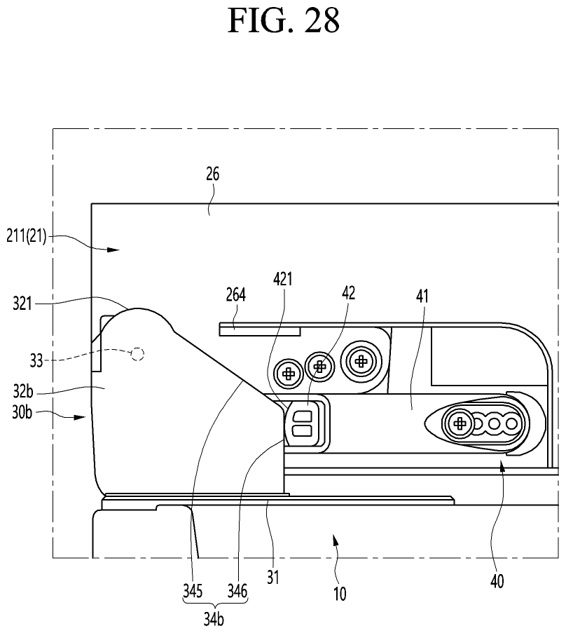

In addition, when the door 21 reaches the third set angle α3, the damping device 40 passes the end portion of the pressing part 345, as illustrated in FIG. 27. In addition, when the door 21 is rotated more than the third set angle α3, the damping device 40 is in contact with the restraining part 346, as illustrated in FIG. 28.

In this process, the door is closed smoothly while maintaining a sufficiently decelerated state by the damping device 40. In addition, at the moment the door 21 is closed, no substantial damping force is applied from the damping device 40, thereby ensuring stable closing of the door 21.

Meanwhile, the present disclosure may have various other embodiments in addition to the above-described embodiments. The fifth embodiment of the present disclosure is characterized in that a stopper and a damping device on the door are in contact with the hinge to close the door while decelerating.

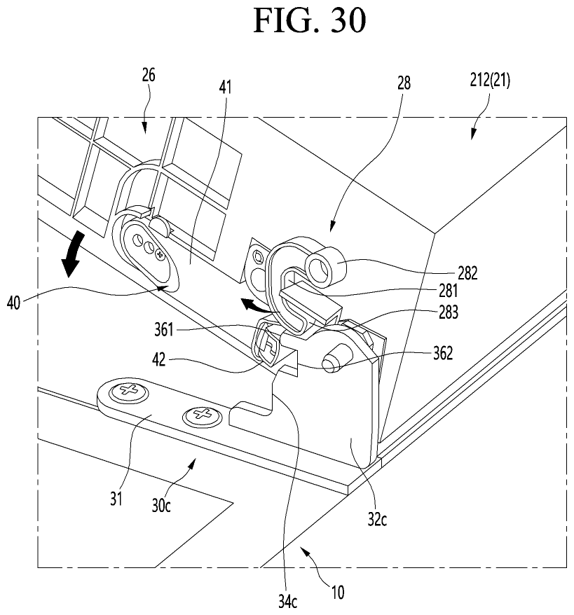

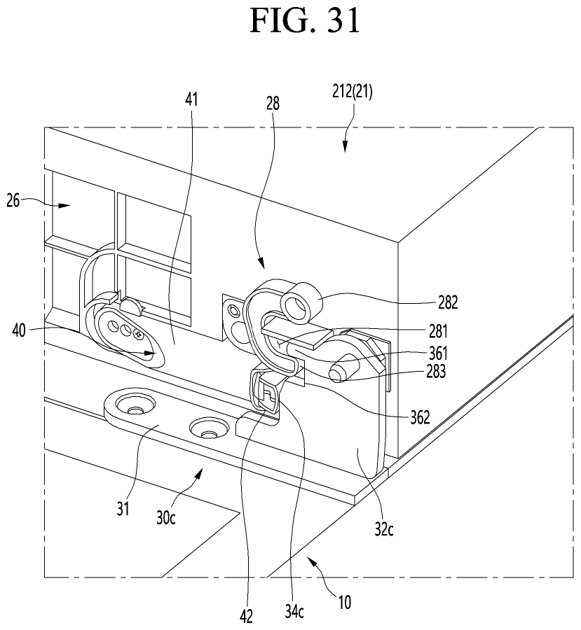

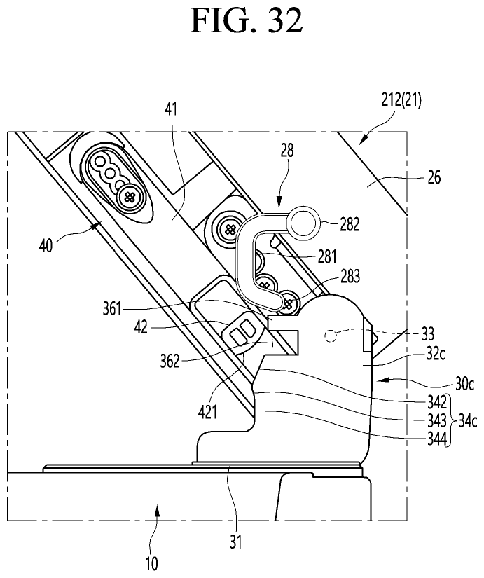

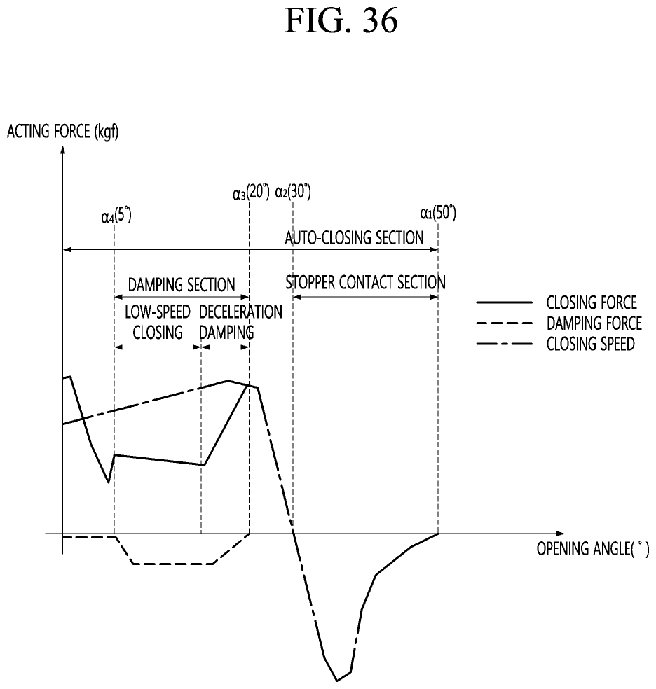

FIG. 30 is a partial perspective view illustrating the door in an open state according to the fifth embodiment of the present disclosure, in addition, FIG. 31 is a partial perspective view illustrating the door in a closed state, FIGS. 32 to 35 are views illustrating changes in the state of the damper device and the door according to the rotation angle of the door, and FIG. 36 is a graph illustrating the change in damping force and closing force and the change in closing speed according to the rotation angle of the door.

As illustrated, the door 21 of the refrigerator 1 according to the fifth embodiment of the present disclosure can be rotatably mounted by the hinge 30c. Additionally, the damping device 40 may be mounted on the cap decoration 26 forming the lower surface of the door 21. The damping device 40 may include a housing 41 and a push member 42. In addition, although the internal structure of the damping device 40 is not illustrated, it may have the same structure as the damping device 40 of the first or second embodiment described above.

The housing 41 is coupled to the cap decoration 26, and the push member 42 can selectively be in contact with the hinge 30c according to the rotation state of the door 21. In addition, when the door 21 is rotated in the closing direction, the push member 42 may be in contact with the contact part 34c of the hinge 30c to provide a damping force to the door 21.

Additionally, a stopper 28 may be formed on the lower surface of the door 21, that is, the cap decoration 26. The stopper 28 may be formed of an elastic structure or material. For example, the stopper 28 may be made of plastic material.

The stopper 28 may be formed in a ring shape, and a fixing part 282 at one end of the stopper 28 may be fixed to the lower surface of the door 21. Additionally, the remaining portion of the stopper 28 extending from the fixing part 282 is not fixed and may be elastically deformed.

The stopper 28 may include a recessed stopper groove 281 into which the locking part 361 of the hinge 30c is inserted. The stopper groove 281 may be open toward the hinge plate 32c. In addition, a rounded part 283 is formed at the end portion of the stopper 28 so that the rounded part can be in contact with and be locked with the hinge 30c while the door 21 is rotated.

The hinge 30c may include the hinge bracket 31 and the hinge plate 32c. The hinge plate 32c may be provided with a hinge shaft 33 (in FIG. 32) that is axially coupled to the door 21. In addition, the locking part 361 and the locking groove 362 are formed on the hinge plate 32c so that it can be in contact with and be restrained by the stopper 28.

In detail, the locking part 361 may protrude outward from the circumferential surface of the hinge plate 32c. Additionally, the outer surface of the locking part 361 is rounded so that the stopper 28 can be easily moved in a contact state. Additionally, the locking part 361 may be formed at a position where contact with the stopper 28 starts when the door 21 is opened at an angle equal to the first set angle α1. The locking part 361 starts contact when the door 21 is closed at the first set angle α1 or less, and the end portion of the stopper 28 may be accommodated inside the locking groove 362 beyond the locking part 361 when the door 21 is rotated further than the first set angle α1. For example, the first set angle α1 may be approximately 50° based on the front surface of the cabinet 10.

The locking groove 362 may be recessed at a position in contact with the locking part 361. Additionally, the locking groove 362 may be formed between the locking part 361 and the contact part 34c so that the end portion of the stopper 28 is inserted. The locking groove 362 is recessed around the hinge plate 32c, and may be recessed to a size that can accommodate the rounded part 283 of the stopper 28.

A contact part 34c may be formed around the hinge plate 32c. The contact part 34c may press the push member 42 in the process of closing the door 21. The contact part 34c is formed to be inclined or rounded so that a damping force is generated by pressing the push member 42 in the process of closing the door 21.

Meanwhile, the contact part 34c may be divided into multiple sections so that the damping force provided to the door 21 varies according to the rotation angle of the door 21. As an example, the contact part 34c may include a second part 342, a third part 343, and a fourth part 344. The second part 342, third part 343, and fourth part 344 may be referred to as a pressing part 342, a holding part 343, and a restraining part 344, respectively.

In the process of closing the door 21, the stopper 28 first comes into contact with the locking part 361, and when the door 21 is further closed, the push member 42 may be moved in a state of being in contact with the contact part 34c.

Looking at the process of closing the door of this structure, the door 21 is rotated and closed in an open state by a user's manipulation. In addition, as illustrated in FIG. 32, the door can freely rotate without both the stopper 28 and the damper device 40 contacting the hinge until the first set angle α1 is reached. In addition, when the auto-closing device 27 of the above-described embodiment is provided, the door 21 can be closed by the auto-closing device 27 when the door rotates to the first set angle α1. For example, the first set angle α1 may be 50°.

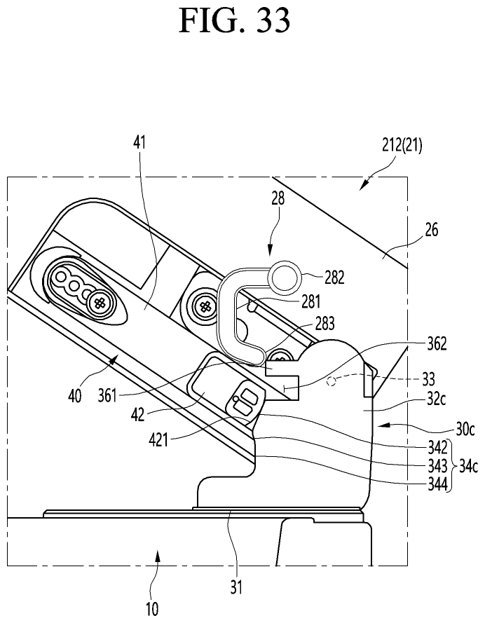

In addition, as illustrated in FIG. 33, when the door 21 is rotated to the first set angle α1, the stopper 28 comes into contact with the locking part 361. In addition, as the door 21 is further rotated in the closing direction, the stopper 28 is partially elastically deformed. In addition, the rounded part 283 of the stopper 28 moves while in contact with the rounded outer surface of the locking part 361. From the moment the stopper 28 starts to come into contact with the locking part 361, the rotational speed of the door 21 may be reduced due to the resistance of the stopper 28.

In addition, as illustrated in FIG. 33, when the door 21 is rotated to the second set angle α2, the end portion of the stopper 28 exceeds the protruding portion of the locking part 361. For example, the second set angle α2 may be 30°. When the end portion of the stopper 28 passes the locking part 361, the resistance of the stopper 28 can be removed, and the door 21 rotates more quickly in the closing direction. At this time, the door 21 can automatically rotate in the closing direction without any additional manipulation due to the elasticity of the stopper 28.

When the door 21 is further rotated in the closing direction and closed at the third set angle α3 or less, the push member 42 starts to be in contact with the contact part 34c. For example, the third set angle α3 may be 20°. In addition, the push member 42 can be moved to a state where the push member is in contact with the second part 342. The stroke may be increased by contact between the push member 42 and the contact part 34c, and the damping force of the damping device 40 may be increased.

Accordingly, the total closing force applied to the door 21 can be reduced by the increased damping force. In addition, as the door 21 rotates in the closing direction, the closing force may be reduced by the damping force. In other words, the door 21 may be closed while rotating at a reduced speed equal to the damping force provided by the damping device 40.

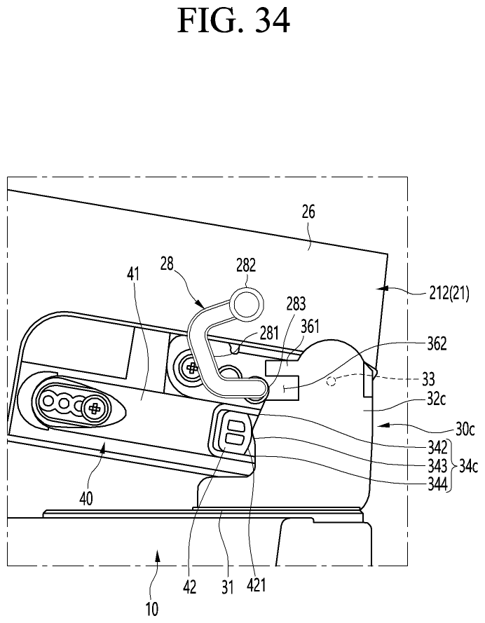

In addition, as illustrated in FIG. 34, when the door 21 is rotated to the fourth set angle α4, the push member 42 can be moved into contact with the third part 343. While passing through the third part 343, the stroke of the push member 42 may be slightly increased or maintained, so that the damping device 40 does not substantially provide a damping force. Accordingly, the door 21 can be easily closed by the torque or inertial force provided by the auto-closing device 27 at the fourth set angle α4 or less.

When the door 21 is rotated at the fourth set angle α4 or less, the damping device 40 does not provide damping force, so the rotation speed of the door 21 is maintained and the door 21 is softly closed.

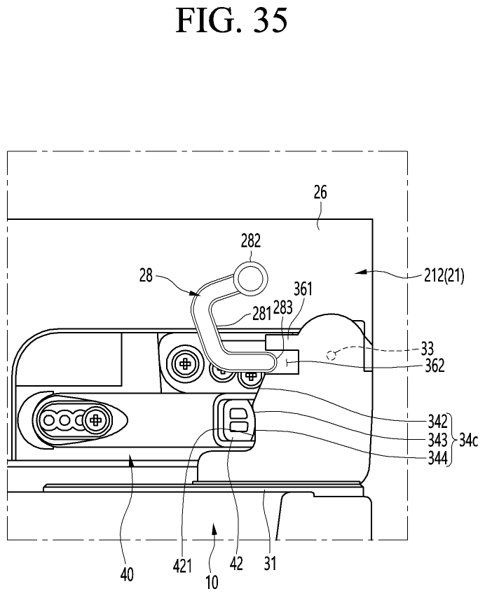

In addition, as illustrated in FIG. 35, when the door 21 is completely closed, the push member 42 can maintain contact with the fourth part 344. In addition, the end portion of the stopper 28 can be inserted into the locking groove 362, and the door 21 can be maintained in a more reliably closed state.

Meanwhile, the present disclosure may have various other embodiments in addition to the above-described embodiments. The sixth embodiment of the present disclosure is characterized by a shape of an inclined contact part of the hinge. In addition, the sixth embodiment of the present disclosure may have the same configurations as the above-described embodiment except for the shape of the hinge.

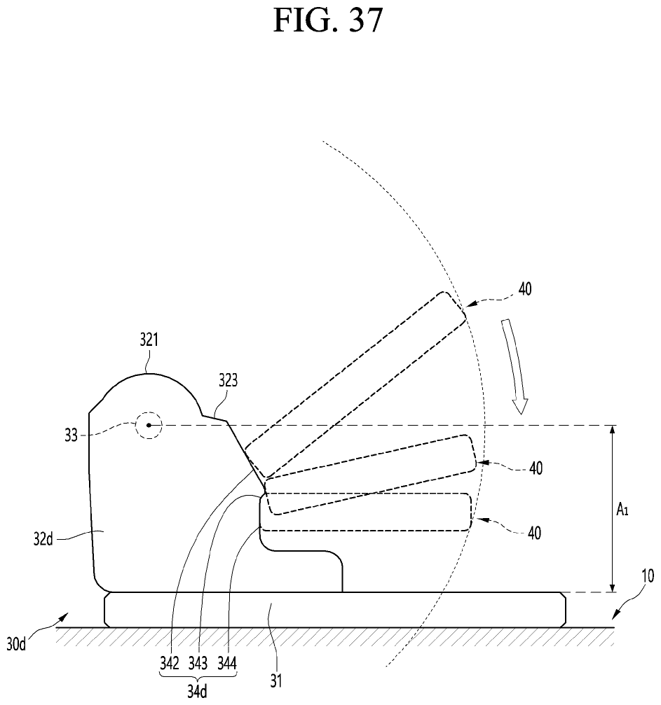

FIG. 37 is a view illustrating the contact state between the hinge and the damping device according to the sixth embodiment of the present disclosure.

As illustrated, the door 21 of the refrigerator 1 according to the sixth embodiment of the present disclosure can be rotatably mounted by a hinge 30d. Additionally, the hinge 30d may include a hinge bracket 31 mounted on the cabinet 10 and a hinge plate 32d protruding forward from the hinge bracket 31. In addition, the hinge plate 32d may be provided with a hinge shaft 33 that is axially coupled to the door 21.

A damping device 40 may be provided on the lower surface of the door 21. The damping device 40 is an oil damper and may have the same structure as the first or second embodiment described above. Of course, the damping device 40 may also have another structure consisting of an oil damper.

In addition, as the door 21 rotates, the end portion of the damping device 40 may be in contact with the contact part 34d of the hinge plate 32d. The contact part 34d may have a shape that can adjust the stroke of the damping device 40 according to the rotation angle of the door.

The hinge plate 32d may be formed in a plate shape with a predetermined thickness. In addition, the side surface may be formed by the circumferential surface between the upper surface and the lower surface. Additionally, a rotating part 321 may be formed at one end of the side of the hinge plate 32d to avoid interference from the stopper 364. Additionally, a connecting part 323 may be formed at one end of the rotating part 321 to connect the rotating part 321 and the contact part 34d. The rotating part 321 and the connecting part 323 are portions that do not contact the damping device 40 in a process of rotating the door 21. The rotating part 321 and the connecting part 323 may be omitted as needed.

The contact part 34d may be formed at one end of the connecting part 323. In addition, the contact part 34d may extend from a position in contact with the damping device 40 when the door 21 is rotated by a set angle (for example, 40° to) 50° to a position in contact with the damping device 40 when the door 21 is completely closed. In other words, the damping device 40 can be moved in contact with the contact part 34d until the door 21 is closed while the door 21 is rotated by a set angle.

Additionally, the contact part 34d may be formed such that the stroke thereof increases in the rotational direction in which the door is closed. Although there may be sections where the stroke is the same in some sections, the overall stroke from one end to the other end of the contact part 34d may be formed to increase.

The contact part 34c may include a second part 342. In addition, the contact part may further include a third part 343 and a fourth part 344. The second part 342, third part 343 and the fourth part 344 may be referred to as a pressing part 342, a holding part 343, and a restraining part 344, respectively. In addition, at least a portion of the contact part 34d may be located in the area A1 between the hinge bracket 31 and the hinge shaft 33.

The second part 342 may be formed to have an inclination that moves away from the hinge shaft 33 in the rotation direction in which the door is closed. Therefore, when the door 21 is rotated while the damping device 40 is in contact with the second part 342, the stroke of the damping device 40 increases, so that the damping force is continuously applied, and the rotation speed of the door 21 can be reduced. The inclination of the second part 342 may be set in various ways according to the specifications of the door 21 to adjust the closing speed of the door 21.

The third part 343 may extend from the end portion of the second part 342. Additionally, the third part 343 may have the same or similar distance from the hinge shaft 33 at both ends. In addition, when the door 21 is rotated at the set angle (for example, 5 to 7 degrees) or less, the damping device 40 may come into contact with the three parts 343. Therefore, while the door 21 is rotated in a state where the damping device 40 is in contact with the second part 342, the damping force is not applied from the damping device 40, and the door 21 is allowed to close naturally by inertia or the torque of the auto-closing device 27.

The fourth part 344 extends from the third part 343 and may extend in a direction crossing the damping device 40. In addition, when the door 21 is completely closed, the damping device 40 can come into contact with the fourth part 344. Therefore, the fourth part 344 can support the damping device 40 without changing the stroke while in contact with the end portion of the damping device 40, and maintain the door 21 in a closed state.

Meanwhile, the present disclosure may have various other embodiments in addition to the above-described embodiments. The seventh embodiment of the present disclosure is characterized by a shape of a multi-stage inclined contact part of the hinge.

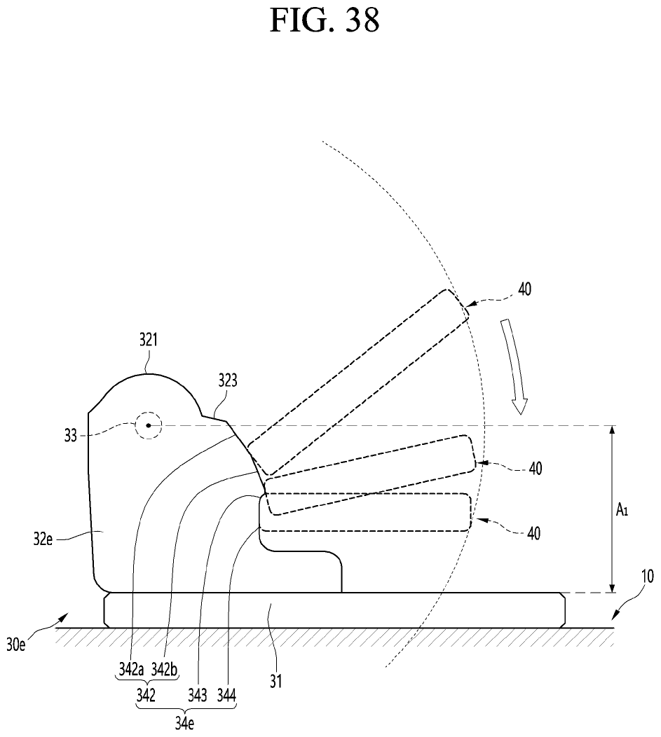

FIG. 38 is a view illustrating the contact state between the hinge and the damping device according to the seventh embodiment of the present disclosure.

As illustrated, the structure of the hinge 30e according to the seventh embodiment of the present disclosure is the same as that of the sixth embodiment described above, with the only difference being the contact part 34c.

The contact part 34e may be formed along a circumferential surface forming the thickness of the hinge plate 32e. The contact part 34c may extend from a position in contact with the damping device 40 when the door 21 is rotated by a set angle (for example, 40° to) 50° to a position in contact with the damping device 40 when the door 21 is completely closed. In other words, the damping device 40 can be moved in contact with the contact part 34e until the door 21 is closed while the door 21 is rotated by a set angle.

Additionally, the contact part 34e may be formed such that the stroke thereof increases in the rotational direction in which the door is closed. Although there may be sections where the stroke is the same in some sections, the overall stroke from one end to the other end of the contact part 34c may be formed to increase.

The contact part 34c may include a second part 342. Additionally, the contact part 34c may further include a third part 343 and a fourth part 344. The second part 342, third part 343 and the fourth part 344 may be referred to as a pressing part 342, a holding part 343, and a restraining part 344, respectively. In addition, at least a portion of the contact part 34e may be located in the area A1 between the hinge bracket 31 and the hinge shaft 33.

The second part 342 may be composed of a high damping part 342a and a low damping part 342b. In the present embodiment, it is explained as an example that the second part 342 is composed of two parts, that is, a high damping part 342a and a low damping part 342b, but may be composed of three or more damping parts with different slopes.

The high damping part 342a may be formed at one end of the contact part 34e closest to the hinge shaft 33. Additionally, the high damping part 342a extends in the rotational direction in which the door 21 is closed, and may have an inclination that moves away from the hinge shaft 33 as it extends.

Additionally, the low damping part 342b may extend from the end portion of the high damping part 342a to the other end portion of the second part 342. The low damping part 342b also extends in the rotational direction in which the door 21 is closed, and may have an inclination that moves away from the hinge shaft 33 as it extends.

At this time, the high damping part 342a may have a smaller slope than the low damping part 342b. Therefore, when rotated by the same angle, the stroke in the high damping part 342a can be formed to be longer than the stroke in the low damping part 342b. In other words, while the damping device 40 passes through the high damping part 342a, a larger damping force may be applied to the door.

Accordingly, by providing a larger damping force at the initial stage when the door 21 stars to close, the rotational speed of the door 21 can be made relatively slower. In addition, when the door 21 has been closed to some extent, the rotation speed of the door 21 can be increased faster. In this way, the closing quality of the door 21 can be improved by adjusting the closing speed for each rotation angle of the door 21 in the second part 342.

Meanwhile, a low damping part 342b may be disposed at one end of the contact part 34e closest to the hinge shaft 33, and then a high damping part 342a may be disposed.

Meanwhile, the present disclosure may have various other embodiments in addition to the above-described embodiments. An eighth embodiment of the disclosure is characterized by a shape of a recessed contact part of the hinge.

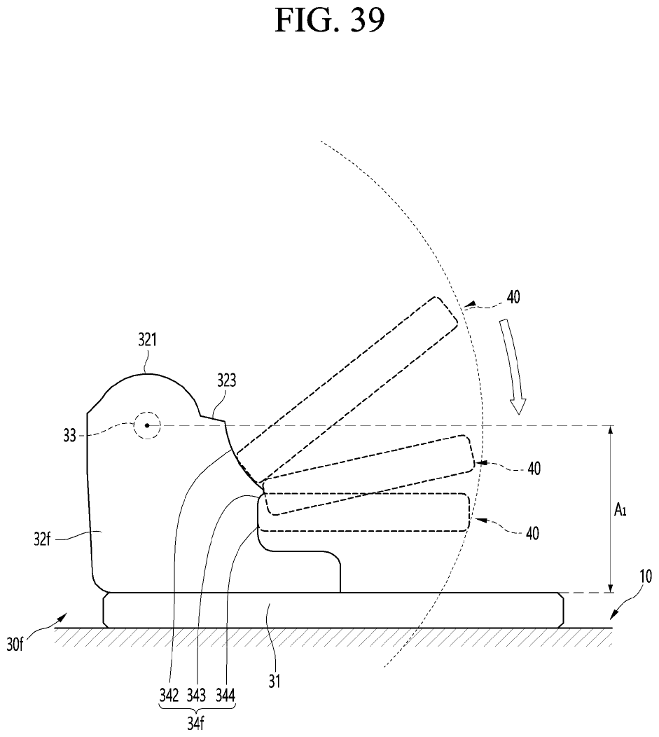

FIG. 39 is a view illustrating the contact state between the hinge and the damping device according to the eighth embodiment of the present disclosure.

As illustrated, the hinge 30f according to the eighth embodiment of the present disclosure is the same as the sixth embodiment described above, with the only difference being the structure of the contact part 34f.

The contact part 34f may be formed along a circumferential surface forming the thickness of the hinge plate 32f. The contact part 34f may include a second part 342. The second part 342 may be formed in a concave shape that is recessed toward the hinge shaft 33. The second part 342 may be formed in a rounded shape from one end closest to the hinge shaft 33 to the other end where the third part 343 starts. In addition, it may be recessed in a direction close to the hinge shaft 33.

Compared to the sixth embodiment, the stroke of the damping device 40 within the second part 342 may be relatively shorter. In addition, the damping force provided by the damping device 40 may be smaller.

When the weight of the door 21 is light, the rotational speed of the door 21 can be reduced with less force, so the hinge 30f may be suitable for a door with a lower weight than the door in the embodiment of FIG. 6.

In addition, in the case of the damping device 40 in which the damping force is excessively large, if the weight of the door 21 is light, a problem may occur in which the door 21 cannot be completely closed, so the second part 342 can appropriately adjust the damping force to match the weight of the door 21.

Meanwhile, the present disclosure may have various other embodiments in addition to the above-described embodiments. The ninth embodiment of the present disclosure is characterized by a shape of a protruding contact part of the hinge.

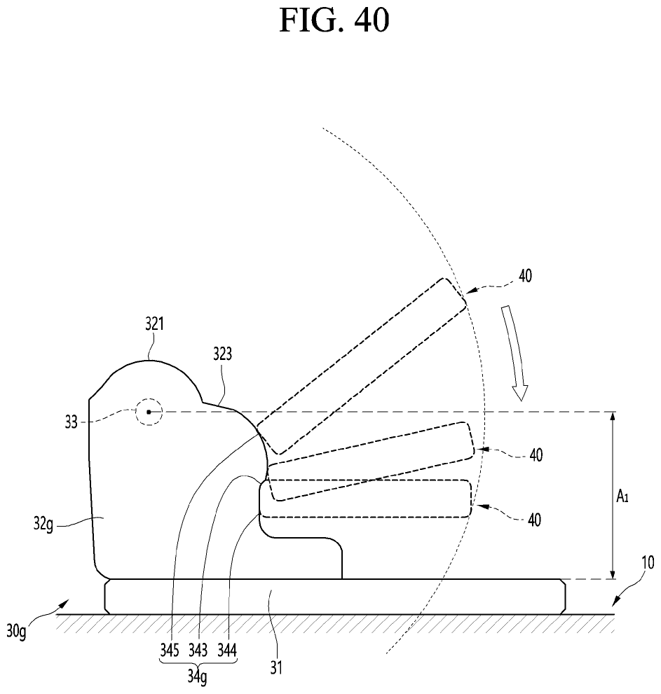

FIG. 40 is a view illustrating the contact state between the hinge and the damping device according to the ninth embodiment of the present disclosure.

As illustrated, the structure of the hinge 30g according to the ninth embodiment of the present disclosure is the same as the above-described eighth embodiment, with the only difference being the structure of the contact part 43g.

The contact part 34g may be formed along a circumferential surface forming the thickness of the hinge plate 32f. The contact part 34g may include a second part 345. The second part 345 may be formed in a convex shape that protrudes in a direction away from the hinge shaft 33. The second part 345 may be formed in a rounded shape from one end closest to the hinge shaft 33 to the other end where the third part 343 starts. In addition, the second part may protrude in a direction away from the hinge shaft 33.

Compared to the sixth embodiment, the stroke of the damping device 40 within the second part 345 may be relatively longer. Additionally, the damping force provided by the damping device 40 may be large.

When the weight of the door 21 is heavy, a larger damping force is required to slow down the rotational speed of the door 21, so the hinge 30g may be suitable to the door heavier than the door in the embodiment of FIG. 6.

In addition, in the case of the damping device 40 with an excessively small damping force, if the weight of the door 21 is heavy and the door 21 accelerates in the process of closing, the speed of the door cannot be effectively reduced, the damping force of the second part 345 can be appropriately adjusted to match the weight of the door 21.

Meanwhile, the present disclosure may have various other embodiments in addition to the above-described embodiments. A tenth embodiment of the present disclosure is characterized by the disposition relationship between the hinge shaft of the hinge and the contact part.

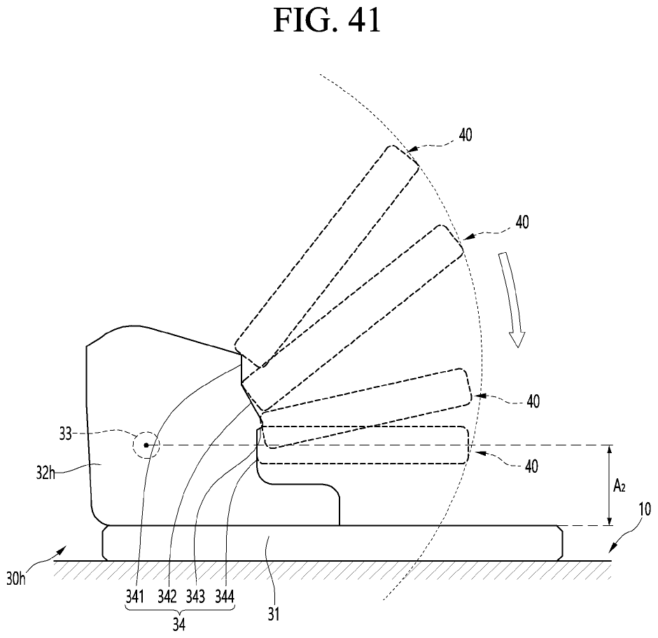

FIG. 41 is a view illustrating the contact state between the hinge and the damping device according to the tenth embodiment of the present disclosure.

As illustrated, the structure of the hinge 30h according to the tenth embodiment of the present disclosure is the same as the first embodiment described above, with the only difference being the disposition relationship between the hinge shaft 33 and the contact part 34.

The contact part 34 may be formed along a circumferential surface forming the thickness of the hinge plate 32h. The contact part 34 may be formed such that the stroke thereof increases in the rotational direction in which the door is closed. Although there may be sections where the stroke is the same in some sections, the overall stroke from one end to the other end of the contact part 34 may be formed to increase. In addition, the contact part 34 may include a first part 341, a second part 342, a third part 343, and a fourth part 344 in the rotational direction in which the door is closed. Since the structure and shape of the contact part 34 are the same as those of the first embodiment described above, detailed description thereof will be omitted.

A hinge shaft 33 coupled to the door 21 may be formed on the hinge plate 32h. When the thickness of the door 21 is thinner than that of the door in the first embodiment, the hinge shaft 33 may be located closer to the front surface of the cabinet 10 than in the first embodiment.

In addition, the contact part 34 requires a length to reduce speed by being in contact with the damping device 40. Accordingly, at least a portion of the contact part 34 may be located outside the area A2 between the hinge shaft 33 and the front surface of the cabinet 10.

A portion of the contact part 34 may be located within the area A2, and the remaining portion thereof may be located further forward than the hinge shaft 33. In detail, among the contact parts 34, the first part 341, the second part 342, and the third part 343 where substantial damping is performed may be disposed at the front of the area A2. In addition, in the direction in which the door 21 is closed, the damping device 40 is in contact with the contact part 34 at the front of the area A2 to provide a damping force to the door 21.

In addition, at least a portion of the fourth part 344 may be disposed to overlap the area A2. Accordingly, when the door 21 is completely closed, the damping device 40 can maintain a state of being in contact with the fourth part 344 within the area A2.

In this way, even in the structure of the door 21 with a thin thickness, it is possible to effectively slow down the door 21 by providing a damping force in the process of closing the door 21. In addition, at the moment when the door 21 is closed, the damping force is not applied, thereby ensuring that the door 21 closes smoothly.

Meanwhile, the present disclosure may have various other embodiments in addition to the above-described embodiments. The eleventh embodiment of the present disclosure is characterized in that the damping device is disposed to face the cabinet.

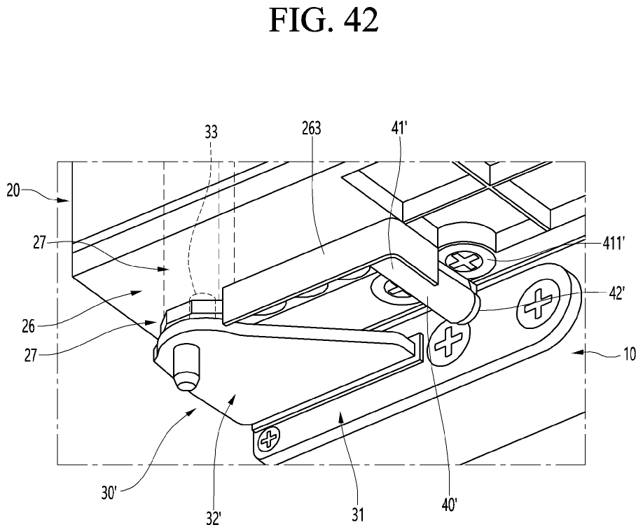

FIG. 42 is a partial perspective view illustrating a refrigerator equipped with a damper device according to the eleventh embodiment of the present disclosure.

As illustrated, the auto-closing device 27 may be mounted on the cap decoration 26 of the door 20 of the refrigerator 1 according to the eleventh embodiment of the present disclosure. Therefore, the door 21 can be closed at a set angle or less by the auto-closing device 27.

The hinge 30′ may include the hinge bracket 31 mounted on the cabinet 10 and a hinge plate 32′ extending forward from the hinge bracket 31. The hinge plate 32′ may be provided with a hinge shaft 33. The hinge shaft 33 may be coupled with the auto-closing device 27.

Meanwhile, the cap decoration 26 may be provided with the damping device 40′. The damping device 40 may have the same structure as the second embodiment described above, with the only difference being the shape and disposition direction of the housing 41′ and the push member 42′.

Additionally, the shielding part 263 is formed on the cap decoration 26 to shield the damping device 40′. Additionally, the rear end of the damping device 40′ may be supported in contact with the shielding part 263.

The damping device 40′ may be disposed so that the stroke direction thereof crosses the front surface of the cabinet 10. In other words, it may be configured that the push member 42′ of the damping device 40′ can be moved in the front and rear direction, and when the door 21 is closed, it is in contact with the front surface of the cabinet 10 or the hinge bracket 31 to provide damping force.

When the door 21 is opened at a set angle or more, the damping device 40′ and the hinge bracket 31 is not in contact with each other, and the push member 42′ can be maintained in the maximum protruding state thereof.

In addition, the auto-closing device 27 as in the above-described embodiment is provided so that the door 21 can be rotated to automatically close before the damping device 40′ comes into contact with the hinge bracket 31.

When the door 21 is rotated in the closing direction by a set angle or more, the hinge bracket 31 may press the push member 42′ to apply a damping force.

As in the second embodiment described above, the damping device 40′ is formed with at least two of the multi-stage damping parts 432, 433, 434, and 435, and the damping force transmitted to the door 21 can be varied according to the opening angle of the door 21. In other words, when the door 21 is rotated at a set angle or less in the closing direction, a high damping force is provided to reduce the rotational speed of the door 21 so that the door 21 closes smoothly. In addition, when the door 21 is completely closed, substantially no damping force is provided or a fine damping force is provided so that the door 21 can be stably closed in the low-speed state.

Therefore, even at the moment when the door 21 is closed, it is possible to prevent impact or noise from the door. In addition, the repulsion force at the moment when the door 21 is closed prevents the door from opening and ensures stable closing.

In addition, the moment when the user opens the door 21, the push member 42′ becomes separated from the hinge bracket 31 or the cabinet 100. Therefore, when the door 21 is opened, the door 21 can be opened without being influenced by the damping device 40′.

Meanwhile, the present disclosure may have various other embodiments in addition to the above-described embodiments. The twelfth embodiment of the present disclosure is characterized in that the damping device is in contact with the lower hinge so that a damping force is applied.

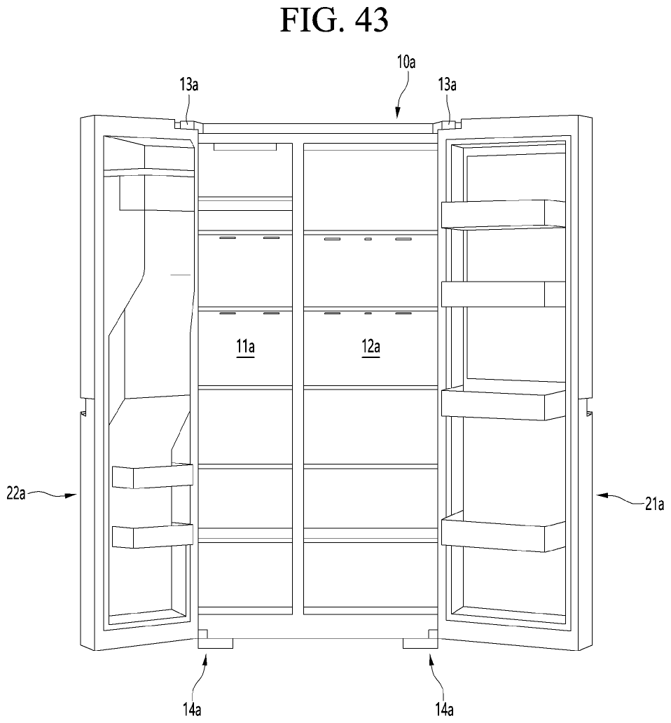

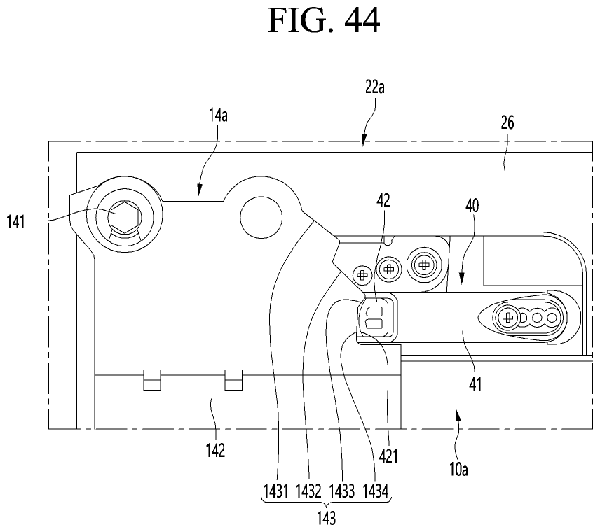

FIG. 43 is a front view illustrating a state where the door of the refrigerator is open according to the twelfth embodiment of the present disclosure, and FIG. 44 is a bottom view illustrating the contact state between the hinge and the damping device of the door.

As illustrated, the inside of the cabinet 10a of the refrigerator according to the twelfth embodiment of the present disclosure may be divided into left and right, and may be provided with a first storage space 11a on the left and a second storage space 12a on the right. For example, the first storage space 11a may be a refrigerating chamber, and the second storage space 12a may be a freezing chamber.

The cabinet 10a may be equipped with a door that opens and closes the first storage space 11a and the second storage space 12a. The door may include a first storage space door 21a that opens and closes the first storage space 11a, and a second storage space door 22a that opens and closes the second storage space 12a. Additionally, the upper and lower ends of the doors 21a and 22a may be rotatably connected to the cabinet 10a by hinges 13a and 14a. The hinge may include an upper hinge 13a and a lower hinge 14a.

The lower hinge 14a is fixedly mounted on the front end of the lower surface of the cabinet 10a, protrudes forward, and can be rotatably coupled to the lower end of the door 22a. The lower hinge 14a is made of a metal material and may include a plate-shaped hinge plate 142 and a hinge shaft 141.

A rear portion of the hinge plate 142 may be coupled to the lower surface of the cabinet 10a. Additionally, the hinge plate 142 protrudes further than the front surface of the cabinet 10a and may extend downward of the door 22a. Additionally, the hinge shaft 141 may protrude upward from the hinge plate 142 and be coupled to the door 22a.

Meanwhile, a contact part 143 may be formed on a portion of the circumferential surface of the hinge plate 142 that protrudes toward the front surface of the cabinet 10a. In addition, the contact part 143 may be formed to extend from front to back along one side of the left and right sides of the hinge plate 142 that is farthest from the hinge shaft 141. The contact part 143 may be formed to be in contact with the damping device 40 to vary the damping force. The contact part 143 may have the same configuration as the contact part 143 of the above-described first embodiment except that the position is different. As an example, the contact part 143 may include a first part 1431, a second part 1432, a third part 1433, and a fourth part 1434.

A cap decoration 26 may be formed on the lower surface of the door 22a. Additionally, the door 22a may be equipped with the auto-closing device 27. When the auto-closing device 27 is mounted, the door 22a is automatically closed by applying force in the closing direction at the set angle or less. The auto-closing device 27 may be provided to be coupled to the rotation shaft at the upper end of the door 22a.

The damping device 40 may be mounted on the cap decoration 26. The damping device 40 may have the same structure as the first or second embodiment described above. The damping device 40 may include a housing 41 fixed to the cap decoration 26 and a push member 42 in contact with the contact part 143.

When the door 22a rotates from the open state in the closed direction, the stroke increase while the push member 42 passes, from the first part 1431, through the second part 1432 and the third part 1433, and the damping device 40 provides a damping force to the door 22a. Accordingly, the rotation speed of the door 22a closed by the auto-closing device 27 may be reduced by the damping force provided by the damping device 40, and the door 22a can be rotated and closed smoothly. In addition, when the push member 42 is in contact with the fourth part 1434, the door 22a maintains a state of being completely closed.

Meanwhile, the present disclosure may have various other embodiments in addition to the above-described embodiments. The thirteenth embodiment of the present disclosure is characterized in that a damping device is in contact with the upper hinge to provide a damping force.

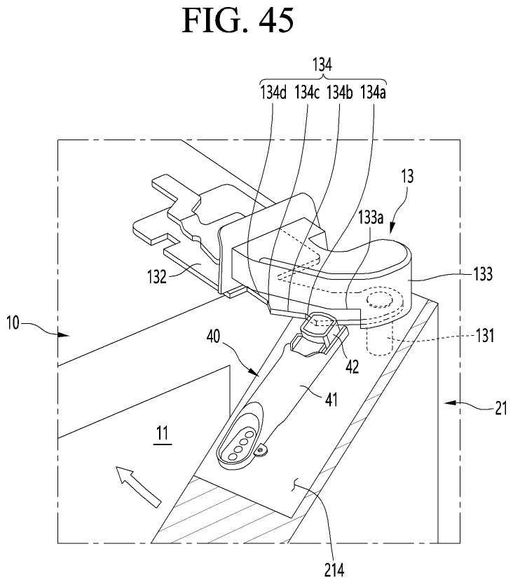

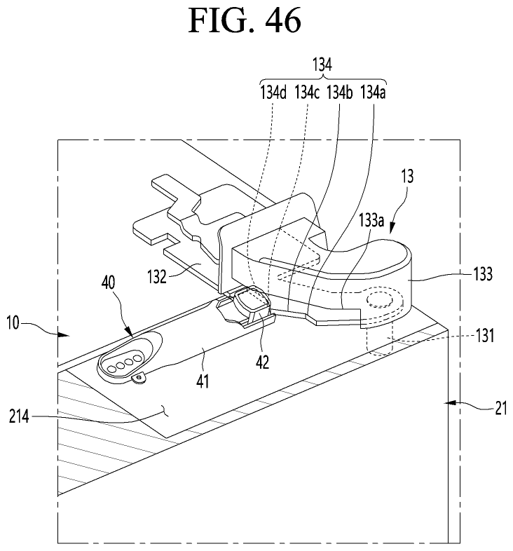

FIG. 45 is a partial perspective view illustrating the state of the hinge and damping device in a state where the door of the refrigerator according to the thirteenth embodiment of the present disclosure is open, and FIG. 46 is a partial perspective view illustrating the state of the hinge and damping device in a state where the door is closed.

As illustrated, the refrigerator according to the thirteenth embodiment of the present disclosure may have an upper hinge 13 mounted on the upper surface of the cabinet 10. The upper hinge 13 may include a hinge plate 132 and a hinge shaft 131.

One end of the hinge plate 132 is fixedly mounted on the cabinet 10, and the other end thereof protrudes forward and may extend to the hinge mounting part 214 at the upper end of the door 21. Additionally, the hinge shaft 131 protrudes downward from the extended end portion of the hinge plate 132 and may be axially coupled to the hinge mounting part 214.

Additionally, a contact part 134 may be formed on the circumferential surface of the hinge plate 132 to be in contact with the damping device 40 when the door 21 is rotated to close. The contact part may be formed on one side of the hinge plate 132 protruding toward the front surface of the cabinet 10. In addition, the contact part 134 may be formed to extend from front to back along one side of the left and right sides of the hinge plate 132 that is farthest from the hinge shaft 131. The contact part 134 may be formed to be in contact with the damping device 40 to vary the damping force. The contact part 134 may have the same configuration as the contact part 134 of the above-described first embodiment except that the position is different. As an example, the contact part 134 may include a first part 134a, a second part 134b, a third part 134c, and a fourth part 134d.

Additionally, the upper hinge 13 may include a hinge cover 133. The hinge cover 133 may be formed to shield the hinge plate 132 from above. The hinge cover 133 opens downward, and a portion of the hinge plate 132 can be accommodated therein. Additionally, a cutout portion 133a is formed on the side of the hinge cover 133 to expose the contact part 134 and allow the end portion of the damping device 40 to pass through.

A hinge mounting part 214 recessed downward may be formed on the upper surface of the door 21. The hinge mounting part 214 may be coupled to the hinge shaft 131 and provide a space where the damping device 40 is mounted.

Additionally, the door 21 may be equipped with the auto-closing device 27. When the auto-closing device 27 is mounted, the door 21 is automatically closed by applying force in the closing direction at the set angle or less. The auto-closing device 27 may be provided on a rotation shaft at the lower end of the door 21.

The damping device 40 may have the same structure as the first or second embodiment described above. The damping device 40 may include a housing 41 fixed to the hinge mounting part 214 and a push member 42 in contact with the contact part 134.

When the door 21 rotates from the open state in the closed direction, the stroke increase while the push member 42 passes, from the first part 134a, through the second part 134b and the third part 134c, and the damping device 40 provides a damping force to the door 21. Accordingly, the rotation speed of the door 21 closed by the auto-closing device 27 may be reduced by the damping force provided by the damping device 40, and the door 21 can be rotated and closed smoothly. In addition, when the push member 42 is in contact with the fourth part 134d, the door 21 maintains a state of being completely closed.

Meanwhile, the present disclosure may have various other embodiments in addition to the above-described embodiments. The fourteenth embodiment of the present disclosure is characterized in that a damping device is provided on one side of the cabinet and is in contact with the door.

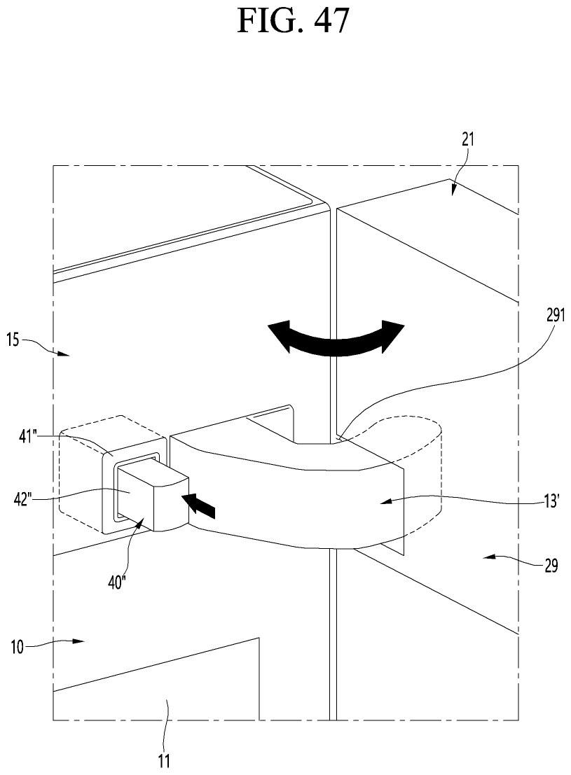

FIG. 47 is a partial perspective view illustrating a refrigerator equipped with a damper device according to the fourteenth embodiment of the present disclosure.

As illustrated in the drawing, a hinge may be provided on the upper surface of the refrigerator 1 according to the fourteenth embodiment of the present disclosure, and the door may be rotatably connected by the hinge.

The hinge 13′ may be located on one of the left and right sides of the upper surface of the cabinet 10. Additionally, a top cover 15 may be provided on the upper surface of the cabinet 10. Additionally, the hinge 13′ may pass through the front surface of the top cover 15 and protrude forward.

The protruding end portion of the hinge 13′ may be inserted into the hinge mounting part 291 formed on the upper portion of the door 21 and axially coupled thereto. The upper cap decoration 29 may be provided on the upper portion of the door 21, forming the upper surface of the door 21, and the hinge mounting part 291 may be recessed at the side end of the upper cap decoration 29.

Additionally, a damping device 40″ may be mounted on the top cover 15. The damping device 40″ may be disposed on the side of the hinge 13′. The damping device 40″ may be in contact with the rear surface of the door 21 when the door 21 is closed and may decelerate the door 21.

The damping device 40″ may have the same structure as the second embodiment described above, with the only difference being the shape and disposition direction of the housing 41″ and the push member 42″. At least a portion of the housing 41″ may be disposed inside the top cover 15. Additionally, the push member 42″ inserted into the housing 41″ may penetrate the front surface of the top cover 15 and protrude forward.

When the door 21 is opened more than a set angle, the damping device 40″ and the door 21 is not in contact with each other, and the push member 42″ may be maintained in the maximum protruding state thereof.

In addition, although not illustrated, the auto-closing device 27 of the door 21 is provided so that the door 21 may rotate to automatically close before the door 21 is in contact with the damping device 40″.

When the door 21 is rotated in the closing direction by the set angle or more, the rear surface of the door 21 can be pressed against the push member 42″ so that a damping force is applied.

As in the second embodiment described above, the damping device 40″ is formed with at least two of the multi-stage damping parts 432, 433, 434, and 435, and thus the damping force transmitted to the door 21 can be varied according to the opening angle of the door 21.

In other words, when the door 21 is rotated at the set angle or less in the closing direction, a high damping force is provided to reduce the rotational speed of the door 21 so that the door 21 closes smoothly. Additionally, when the door 21 is completely closed, there may be substantially no damping force or only a small damping force may be provided so that the door 21 can be stably closed in the low-speed state.

In addition, the moment when the user opens the door 21, the push member 42″ falls off the door 21. Therefore, when opening the door 21, the door 21 can be opened without being affected by the damping device 40″.

What is claimed is:

1. A refrigerator comprising:
a cabinet having a storage space;
a first door configured to open and close at least a portion of the storage space;
a hinge connecting the first door to the cabinet, the hinge having a contact surface; and
a damper located on the first door, the damper being in contact with the contact surface of the hinge over a portion of a rotation of the first door in a closing direction to slow down a rotational speed of the first door,
wherein the damper includes a first damping state configured to exert a first damping force and a second damping state configured to exert a second damping force, and
wherein the first damping force is greater than the second damping force.

2. The refrigerator of claim 1, wherein, when a closing angle of the door relative to the closed position is between a first angle and a second angle, the damper is in the first damping state, and
when the closing angle of the door is less than the second angle, the damper is in the second damping state.

3. The refrigerator of claim 1, wherein the contact surface includes a pressing portion and a restraining portion,
wherein, when the damper contacts the pressing portion, the damper is in the first damping state, and
wherein, when the damper contacts the restraining portion, the damper is in the second damping state.

4. The refrigerator of claim 1, wherein the damper includes:
a cylinder having a space to accommodate oil therein, the cylinder having a first end and a second end, the first end having an opening;
a push member on the cylinder;
a sealing cap configured to seal the opening of the cylinder;
a rod extending through the sealing cap from inside the cylinder;
a piston coupled to the rod, the piston configured to move within the space of the cylinder; and
an elastic member located in the space of the cylinder, the elastic member configured to apply an elastic force to the piston, and
wherein a position of the piston within the space of the cylinder determines whether the damper is in the first damping state or the second damping state.

5. The refrigerator of claim 4, wherein the cylinder includes a plurality of damping regions between the first end of the cylinder and the second end of the cylinder, and
wherein at least one damping region has a larger diameter relative to another damping region located between the at least one damping region and the first end of the cylinder.

6. The refrigerator of claim 5, wherein the first door includes an auto-closing device configured to provide a closing force to the first door to assist in rotating the first door towards a closed position,
wherein the piston is configured to decelerate the first door as the piston passes through at least one damping region of the plurality of damping regions when the damper is in the first damping state, and
wherein the first door is accelerated when the piston passes through a damping region of the plurality of damping region that is farthest from the opening when the damper is in the second damping state.

7. The refrigerator of claim 1, wherein the first door includes an auto-closing device configured to provide a closing force to the first door to assist in rotating the first door towards a closed position, and
wherein the damper is configured to contact the hinge to sequentially provide the first damping force and the second damping force to the first door after the auto-closing device starts to provide the closing force to the first door.

8. The refrigerator of claim 7, wherein the auto-closing device extends along a rotational axis of the first door,
wherein the auto-closing device is configured to start operating when a closing angle of the first door with respect to the closed position is at a first set angle, and wherein the damper is configured to start contacting the hinge when the closing angle of the first door is at a second set angle smaller than the first set angle.

9. The refrigerator of claim 8, further comprising a second door, the first door and the second door being located adjacent each other in a left-right direction,
wherein the first door includes a pillar configured to rotate when the first door is closed to shield a space between the first door and the second door, and
wherein the cabinet includes a pillar guide configured to guide rotation of the pillar.

10. The refrigerator of claim 9, wherein the second damping force of the damper is reduced while the pillar is in contact with the pillar guide.

11. The refrigerator of claim 10, wherein the pillar is configured to be in contact with the pillar guide when the closing angle of the first door is a third set angle or less, and
wherein the second damping force of the damper is reduced when the closing angle of the first door is the third set angle or less.

12. The refrigerator of claim 1, wherein the damper is spaced apart from a rotation shaft of the first door by a set distance such that a torque is generated in a direction opposite to the closing direction about the rotation shaft when the damper is in contact with the hinge.

13. The refrigerator of claim 1, wherein the hinge includes:
a hinge bracket located on the cabinet;
a hinge plate protruding from the hinge bracket, the hinge plate having a contact portion extending along at least a portion of a circumferential surface of the hinge plate; and
a hinge shaft located on the hinge plate, the hinge shaft being coupled to the first door, and
wherein the damper is configured to contact the contact portion when a closing angle of the first door with respect to a closed position of the first door is at a set angle or less.

14. The refrigerator of claim 13, wherein the contact portion includes:
a pressing portion configured to place the damper in the first damping state when the damper contacts the pressing portion as the first door is closed; and
a restraining portion located farther rearward than the pressing portion, the restraining portion being configured to maintain contact with the damper when the first door is in the closed position.

15. The refrigerator of claim 14, wherein a recession depth of the restraining portion is less than a radius of curvature of an end portion of the damper.

16. The refrigerator of claim 14, wherein the contact portion further includes a holding portion located between the pressing portion and the restraining portion, the holding portion extending from the pressing portion such that a distance from the hinge shaft between a starting point of the holding portion and an ending point of the holding portion does not increase.

17. The refrigerator of claim 14, wherein the contact portion further includes a starting portion ahead of the pressing portion such that the damper contacts the starting portion prior to contacting pressing portion as the first door is closed.

18. The refrigerator of claim 13, wherein the first door further includes a stopper configured to restrain the first door, the stopper having a first end connected to the first door and a second end configured to contact the hinge plate, and
wherein the hinge plate includes:
a locking part configured to contact with the stopper to elastically deform the stopper when the first door rotates; and
a locking groove which is recessed rearward of the locking part, the locking groove being configured to receive the second end of the stopper.

19. The refrigerator of claim 18, wherein the contact portion is located between the hinge bracket and the locking groove.

20. The refrigerator of claim 19, wherein the hinge plate is configured such that the damper starts contact with the contact portion after the stopper is in contact with the locking part as the first door is closed.
